(19) United States
(12) Patent Application Publication
(10) Pub. No.: US 2022/0030912 A1
(43) Pub. Date: Feb. 3, 2022

(54) METHODS FOR PRODUCING PROTEINACEOUS FOOD PRODUCT INGREDIENTS, A PET FOOD COMPRISING SAID INGREDIENT AND A METHOD OF REMOVING MALODORS FROM, AND/OR INCREASING THE PALATABILITY OF, SAID INGREDIENT

(71) Applicant: MARS, INCORPORATED, McLean, VA (US)

(72) Inventors: Lucio Yonemoto, Franklin, TN (US); Svetlana Zivanovic, Franklin, TN (US); Ping Guo, Jurong, Zhenjiang (CN)

(73) Assignee: MARS, INCORPORATED, McLean, VA (US)

(21) Appl. No.: 17/299,546

(22) PCT Filed: Dec. 3, 2019
(86) PCT No.: PCT/US2019/064269

§ 371 Date: Jun. 3, 2021

Related U.S. Application Data
(60) Provisional application No. 62/774,590, filed on Dec. 3, 2018.

(51) Int. Cl. A23J 3/34; A23K 10/30; A23K 50/42; A23K 50/45; A23K 50/48; A23K 10/20

(52) U.S. Cl. CPC A23J 3/341; A23K 10/30; A23K 10/20; A23K 50/45; A23K 50/48; A23K 50/42

(57) ABSTRACT

A food product ingredient formed from a keratinous protein-containing material, e.g, feathers, and methods of making the same. The methods include cleaning the keratinous protein-containing material, combining the keratinous protein-containing material with a cereal bran to form a mixture, and hydrolyzing the mixture to form the food product ingredient. Optionally, of the keratinous protein-containing material is cleaned and/or frozen within 5 hours of collection. The methods generate fewer unpleasant odors, and food product ingredients produced by the method can similarly benefit. The food product ingredient may be incorporated into a food product, such as a pet food product.

### CROSS-REFERENCE TO RELATED APPLICATION

This application claims priority to U.S. Provisional Application No. 62/774,590, filed on Dec. 3, 2018, which is herein incorporated by reference in its entirety.

### TECHNICAL FIELD

Provided herein are food product ingredients formed from a keratinous protein-containing material and methods of making the same. The method or process comprises cleaning a keratinous protein-containing material, e.g., feathers, forming a mixture of the keratinous protein-containing proteinaceous material and cereal bran, and hydrolyzing the mixture to produce the food product ingredient, which can be used in digestible food and feed products. The provided methods reduce or eliminate the odor typically associated with conventional hydrolysis methods and/or the odors or off flavors provided in food product ingredients produced therefrom.

### BACKGROUND OF THE INVENTION

World population growth is well known to exert corresponding pressure on the food supply. As the population increases, already costly food ingredients, such as meat protein, may become prohibitively expensive for consumption by pets and companion animals. Thus, there is a need for alternative protein sources that do not compete with the human food chain. Such alternative protein sources may include any protein material containing keratin, including, but not limited to feathers, hair, wool, hide, bristles, horns, hooves, claws, nails, scales, or any other suitable keratin-containing material or mixtures thereof.

While keratin protein materials are generally abundant, inexpensive, and sustainable, they also contain relatively high percentages of sulfur-containing amino acids such as cysteine. Cysteine can form disulfide bonds that contribute to the tertiary structure of the keratin protein and make it strong and durable. This structural durability also impairs digestibility, however, and in order to render keratin proteins digestible, at least partial breakdown of the disulfide bonds is necessitated.

Chemical, enzyme, and heat hydrolysis have been used to denature keratin-containing materials and disrupt the sulfide bonds therein. Any of these methods of hydrolysis can result in the formation of significant off odorants, including, e.g., organosulfur compounds such as mercaptans and hydrogen sulfide. As a result, the environment in a facility in which hydrolysis reactions are conducted can be suboptimal, and can even present a health hazard for employees that are sensitive to such odorants. Further, even if off gases from a hydrolysis process are scrubbed prior to or during venting, manufacturing facilities that perform hydrolysis reactions can have difficulty regulating the release or permeation of odors into the surrounding community. Some amount of off odorants or flavorants may also be present in food products incorporating hydrolyzed keratin materials. In food products that may already have some level of off odorants or flavorants, such as wet pet foods, these additional off odorants or flavorants can limit the consumer acceptance of those foods.

Known methods of ameliorating the odors associated with the hydrolysis of free peptides include the addition of reducing sugars, or other compounds capable of burning in the temperatures employed in hydrolysis and related processes, in relatively large amounts, e.g., 20% or more, or in a ratio of peptides to reducing sugars of about 1:1. However, such additions can lead to other undesirable reactions, such as sugar pyrolysis and caramelization, the impact of which on the hydrolysis of intact proteins is not expected or understood. Further, the inclusion of such large amounts of such sugars may not be acceptable in all contemplated end uses of the hydrolyzed keratin material. This is particularly true since many conventional keratin hydrolysis processes lead to production of undesirable artificial amino acids, such as lanthionine or lysinoalanine, as well as other detrimental compounds well known in the art, in the resultant products. The addition of other undesirable ingredients is thus suboptimal.

Accordingly, there exists a need for improved methods for producing a food product ingredient from a keratinous protein-containing material, such as feathers, that reduces or eliminates the odor associated with the methods and the food product ingredients made therefrom. Further benefit would be provided if the processes employ nutritionally advantageous components.

### SUMMARY OF THE INVENTION

Described herein are food product ingredients formed from a keratinous protein-containing material and methods for making the same. The food product ingredient produced according to the methods disclosed herein may have reduced or eliminated odors typically associated with conventional hydrolysis methods and/or the odors or off flavors provided in food product ingredients produced therefrom.

In one aspect, the present disclosure provides a process for producing a food product ingredient formed from a keratinous protein-containing material, the process including: cleaning the keratinous protein-containing material with a cleaning solution, combining the keratinous protein-containing material and a cereal bran to form a mixture, and subjecting the mixture to hydrolysis under conditions sufficient to hydrolyze the keratinous protein-containing material to form the food product ingredient.

In some embodiments, the keratinous protein-containing material includes feathers, hair, wool, hide, bristles, horns, hooves, claws, nails, scales, or a mixture thereof. For example, in some embodiments, the keratinous protein-containing material includes raw feathers.

In some embodiments, the keratinous protein-containing material is frozen before forming the mixture. The keratinous protein-containing material can be frozen and/or cleaned within five hours of collection of the keratinous protein-containing material.

In some embodiments, the keratinous protein-containing material is cleaned by washing the keratinous protein-containing material with the cleaning solution at least once. In further embodiments, the keratinous protein-containing material is washed three times with the cleaning solution. In some embodiments, the cleaning solution includes water. In some embodiments, the cleaning solution is water. The water can be at ambient temperature or at an elevated temperature.

In further embodiments, the keratinous protein-containing material is subject to pretreatment with a proteolytic enzyme or a reducing agent prior to hydrolysis. In particular embodiments, the keratinous protein-containing material is subject to size reduction prior to hydrolysis.

In some embodiments, the cereal bran is amaranth bran, bulgur bran, farro bran, quinoa bran, spelt bran, teff bran, triticale bran, wild rice bran, wheat bran, corn bran, barley bran, rye bran, millet bran, oat bran, rice bran, sorghum bran, or buckwheat bran. For example, in certain embodiments, the cereal bran is wheat bran, corn bran, barley bran, rye bran, millet bran, oat bran, or rice bran. In further embodiments, the cereal bran is defatted before forming the mixture. In some embodiments, the cereal bran is combined with a solvent (e.g., water) prior to forming the mixture.

In some embodiments, the ratio of cereal bran to solvent is from about 1:0 to about 1:1. In some embodiments, the cereal bran is present in an amount of about 30 wt. %, or about 20 wt. %, or about 10 wt. % or less based upon the total weight of the mixture. In further embodiments, the cereal bran is present in an amount of about 5 wt. % or less based upon the total weight of the mixture.

In some embodiments, the hydrolysis includes one or multiple hydrolysis steps. In some embodiments, the multiple hydrolysis steps each include different types of hydrolysis processes. In other embodiments, the multiple hydrolysis steps each include the same type of hydrolysis process. In certain embodiments, the same type of hydrolysis process of the multiple hydrolysis steps is varied from step to step by the retention time, pressure, temperature, type of enzyme used, or a combination thereof.

In some embodiments, the hydrolysis includes steam hydrolysis. In some embodiments, the steam hydrolysis is performed at a pressure of from about 0 psig to about 200 psig and/or elevated temperature. In further embodiments, the steam hydrolysis is performed for a time period of from about 15 minutes to about 240 minutes (e.g., about 22 minutes).

In other embodiments, the hydrolysis includes enzyme hydrolysis. In some embodiments, the enzyme hydrolysis includes: adding a proteolytic enzyme slurry including a quantity of at least one proteolytic enzyme in an aqueous environment to the mixture to produce a protein slurry; and incubating the protein slurry for a time sufficient to hydrolyze the keratinous protein-containing material. In certain embodiments, the proteolytic enzyme slurry includes an endoprotease, an exoprotease, an endogenous enzyme, or a combination thereof. For example, in some embodiments, the endoprotease is a keratinase, papain, or a combination thereof.

In further embodiments, the hydrolyzed keratinous protein-containing material is subject to further processing including centrifugation, filtration, decanting, drying, sifting, accumulating prior to milling, concentrating, refrigerating, freezing, pasteurizing, acidifying, further hydrolyzing, or a combination thereof. In some embodiments, the hydrolyzed keratinous protein-containing material is dried after hydrolysis. In yet further embodiments, the mixture is subject to intermediate processing prior to hydrolysis, wherein the intermediate processing includes removal of organic or inorganic contaminants, wetting, rinsing, size reduction, addition of a proteolytic enzyme or a reducing agent, or a combination thereof.

In some embodiments, the food product ingredient further includes an antioxidant. The antioxidant can be added to the keratinous protein-containing material before, during, or after hydrolysis.

In another aspect, the present disclosure provides a food product ingredient formed from a keratinous protein-containing material, wherein the food product ingredient is produced by any one of the processes disclosed herein. Stated in another way, the food product ingredient can consist of a hydrolyzed mixture of keratinous protein-containing material and cereal bran and optionally, an amount of one or more antioxidants. The food product ingredient can include up to about 20 wt. % cereal bran, and in some embodiments, desirably includes from about 5 wt. % to about 10 wt. % cereal bran, based upon the total weight of the food product ingredient. The food product ingredient, in turn, can be incorporated into a wet, semi-moist, or dry food in amounts of up to about 25 wt. %, or up to about 20 wt. %, or up to about 15 wt. %, or up to about 10 wt. %, based upon the total weight of the food. At least about 1 wt. % of the food product ingredient may be incorporated into a wet, semi-moist, or dry food, or, at least about 5 wt. %. Acceptable ranges of the food product ingredient in wet, semi-moist, or dry foods are from about 1 wt. % to about 25 wt. %, or from about 5 wt. % to about 20 wt. %, or from about 10 wt. % to about 15 wt. %. The weight percentages provided herein are based upon the total weight of the food product ingredient intermediate mixture, food product ingredient, or food product, as the case may be, and are calculated on a dry matter basis. In some embodiments, the food product ingredient has a total aroma score that is lower than a food product ingredient without cereal bran. In some embodiments, the food product ingredient has a total aroma score of less than 5.5 on a scale of 0 to 15 as measured by quantitative descriptive analysis. In further embodiments, the amount of hexanal in the food product ingredient is less than about 10 ppm and/or the peroxide value of the food product ingredient is less than about 10 mEq/kg fat.

In another aspect, the present disclosure provides a food product ingredient formed from a keratinous protein-containing material, wherein the food product ingredient is produced by a process including: cleaning the keratinous protein-containing material, combining the keratinous protein-containing material and a cereal bran to form a mixture, and subjecting the mixture to hydrolysis under conditions sufficient to hydrolyze the keratinous protein-containing material to form the food product ingredient.

In some embodiments, the keratinous protein-containing material includes feathers, hair, wool, hide, bristles, horns, hooves, claws, nails, scales, or a mixture thereof. For example, in some embodiments, the keratinous protein-containing material includes raw feathers.

In some embodiments, the keratinous protein-containing material is frozen before forming the mixture. The keratinous protein-containing material can be frozen and/or cleaned within five hours of collection of the keratinous protein-containing material.

In some embodiments, the keratinous protein-containing material is cleaned by washing the keratinous protein-containing material with the cleaning solution at least once. In further embodiments, the keratinous protein-containing material is washed three times with the cleaning solution. In some embodiments, the cleaning solution includes water. In some embodiments, the cleaning solution is water. The water can be at ambient temperature or at an elevated temperature.

In further embodiments, the keratinous protein-containing material is subject to pretreatment with a proteolytic enzyme or a reducing agent prior to hydrolysis. In particular embodiments, the keratinous protein-containing material is subject to size reduction prior to hydrolysis.

In some embodiments, the cereal bran is amaranth bran, bulgur bran, farro bran, quinoa bran, spelt bran, teff bran, triticale bran, wild rice bran, wheat bran, corn bran, barley bran, rye bran, millet bran, oat bran, rice bran, sorghum bran, or buckwheat bran. For example, in certain embodiments, the cereal bran is wheat bran, corn bran, barley bran, rye bran, millet bran, oat bran, or rice bran. In further embodiments, the cereal bran is defatted before forming the mixture. In some embodiments, the cereal bran is combined with a solvent (e.g., water) prior to forming the mixture.

In some embodiments, the ratio of cereal bran to solvent is from about 1:0 to about 1:1. The food product ingredient can include up to 20 wt. % cereal bran, and in some embodiments, desirably includes from 5 wt. % to 10 wt. % cereal bran, based upon the total weight of the food product ingredient. In some embodiments, the cereal bran is present in an amount of about 30 wt. %, or about 20 wt. %, or about 10 wt. % or less based upon the total weight of the mixture. In further embodiments, the cereal bran is present in an amount of about 5 wt. % or less based upon the total weight of the mixture.

In some embodiments, the hydrolysis includes one or multiple hydrolysis steps. In some embodiments, the multiple hydrolysis steps each include different types of hydrolysis processes. In other embodiments, the multiple hydrolysis steps each include the same type of hydrolysis process. In certain embodiments, the same type of hydrolysis process of the multiple hydrolysis steps is varied from step to step by the retention time, pressure, temperature, type of enzyme used, or a combination thereof.

In some embodiments, the hydrolysis includes steam hydrolysis. In some embodiments, the steam hydrolysis is performed at a pressure of from about 0 psig to about 200 psig and/or elevated temperature. In further embodiments, the steam hydrolysis is performed for a time period of from about 15 minutes to about 240 minutes (e.g., about 22 minutes).

In other embodiments, the hydrolysis includes enzyme hydrolysis. In some embodiments, the enzyme hydrolysis includes: adding a proteolytic enzyme slurry including a quantity of at least one proteolytic enzyme in an aqueous environment to the mixture to produce a protein slurry; and incubating the protein slurry for a time sufficient to hydrolyze the keratinous protein-containing material. In certain embodiments, the proteolytic enzyme slurry includes an endoprotease, an exoprotease, an endogenous enzyme, or a combination thereof. For example, in some embodiments, the endoprotease is a keratinase, papain, or a combination thereof.

In further embodiments, the hydrolyzed keratinous protein-containing material is subject to further processing including centrifugation, filtration, decanting, drying, sifting, accumulating prior to milling, concentrating, refrigerating, freezing, pasteurizing, acidifying, further hydrolyzing, or a combination thereof. In some embodiments, the hydrolyzed keratinous protein-containing material is dried after hydrolysis. In yet further embodiments, the mixture is subject to intermediate processing prior to hydrolysis, wherein the intermediate processing includes removal of organic or inorganic contaminants, wetting, rinsing, size reduction, addition of a proteolytic enzyme or a reducing agent, or a combination thereof.

In some embodiments, the food product ingredient further includes an antioxidant. The antioxidant can be added to the keratinous protein-containing material before, during, or after hydrolysis.

In some embodiments, the food product ingredient has a total aroma score that is significantly lower than a food product ingredient without cereal bran. In some embodiments, the food product ingredient has a total aroma score of less than 5.5 on a scale of 0 to 15 as measured by quantitative descriptive analysis. In further embodiments, the amount of hexanal in the food product ingredient is less than about 10 ppm and/or the peroxide value of the food product ingredient is less than about 10 mEq/kg fat.

In another aspect, the present disclosure provides a pet food product including a food product ingredient as described in any one of the preceding aspects. In some embodiments, the pet food is a wet pet food, a semi-moist pet food, or a dry pet food. The food product ingredient can be incorporated into a wet, semi-moist, or dry pet food in amounts of up to about 25 wt. %, or up to about 20 wt. %, or up to about 15 wt. %, or up to about 10 wt. %, based upon the total weight of the food. At least about 1 wt. % of the food product ingredient may be incorporated into a wet, semi-moist, or dry pet food, or, at least about 5 wt. %. Acceptable ranges of the food product ingredient in wet, semi-moist, or dry pet foods are from about 1 wt. % to about 25 wt. %, or from about 5 wt. % to about 20 wt. %, or from about 10 wt. % to about 15 wt. %. The weight percentages provided herein are based upon the total weight of the food product ingredient intermediate mixture, food product ingredient, or food product, as the case may be, and are calculated on a dry matter basis. In some embodiments, the food product ingredient is present in the pet food product in an amount of from about 1 wt. % to about 25 wt. %.

In another aspect, the present disclosure provides a method of removing malodors from and/or increasing the palatability of a food product ingredient formed from a keratinous protein-containing material, the method including producing the food product ingredient according to the process disclosed in any one of the preceding aspects.

The methods described result in the minimized production of unpleasant odors during the manufacture of food product ingredients based upon keratinous protein-containing materials, and improved results in this regard as compared to the amount and/or type of odors produced during similar processes wherein bran is added to the process without water, or the keratinous protein-containing material is not cleaned and/or frozen within 5 hours of collection. Food products incorporating the food product ingredients produced by the method are expected to similarly benefit, i.e., and have minimal unpleasant odors associated therewith. Further food products incorporating the food product ingredients may exhibit fewer or lesser degrees of any off flavors that may be exhibited by food products incorporating food product ingredients produced from keratinous protein-containing materials produced conventionally.

The foregoing has outlined broadly the features and technical advantages of the present application in order that the detailed description that follows may be better understood. Additional features and advantages of the application will be described hereinafter which form the subject of the claims of the application. It should be appreciated by those skilled in the art that the conception and specific embodiments disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features believed to be characteristic of the application, both as to the organization and method of operation, together with further objects and advantages, will be better understood from the following description.

### BRIEF DESCRIPTION OF THE DRAWINGS

FIG. 1 is a flow chart of an exemplary embodiment of the methods described herein.

FIG. 2 is a flow chart of another exemplary embodiment of the methods described herein.

FIG. 3 is a flow chart of another exemplary embodiment of the methods described herein.

FIG. 4 is a flow chart of another exemplary embodiment of the methods described herein.

FIG. 5 is a spider chart showing the aroma attributes of comparative and inventive food product ingredients. FM CRF=clean raw feathers, no cereal bran (comparative); FM DRB=cleaned feathers, with cereal bran/water addition (inventive); and FM RRF=raw feathers (comparative).

FIG. 6A is a graph showing changes in amount of hexanal in feather meal samples produced from regular raw feathers (RRF), cleaned raw feathers (CRF), and cleaned raw feathers in the presence on defatted rice bran (DRB) over the course of 12 months.

FIG. 6B is a graph showing changes in peroxide values in feather meal samples produced from regular raw feathers (RRF), cleaned raw feathers (CRF), and cleaned raw feathers in the presence on defatted rice bran (DRB) over the course of 12 months.

FIG. 7A is a graph showing amounts of unpleasant volatile compounds in feather meal samples.

FIG. 7B is a graph showing amounts of pleasant volatile compounds in feather meal samples.

FIG. 7C is a graph showing amounts of neutral volatile compounds in feather meal samples.

FIG. 8A is a schematic diagram showing the methods of washing for samples T1, T2, and T3.

FIG. 8B is a schematic diagram showing the methods of washing for sample T4.

FIG. 9A is a graph showing total biogenic amine (TBA) concentration (mg/kg) compared to number of raw feather washes.

FIG. 9B is a graph showing levels of putrescine, cadaverine, and tyramine, pH, and biogenic amine (BA) index compared to number of raw feather washes.

FIG. 10 is a graph showing change in TBA over the course of 15 days for sample T1.

FIG. 11A is a table showing aroma descriptors and total aroma score assessed in feather meals produced from T1-T4 raw feather samples.

FIG. 11B is a table showing aroma intensity assessed in feather meals produced from T1-T4 raw feather samples.

FIG. 12 is a graph showing aroma score compared to number of washes.

FIG. 13A is a graph showing aroma score and aroma intensity plotted against total biogenic amine content.

FIG. 13B is a graph showing aroma score and aroma intensity plotted against putrescine, cadaverine, and tyramine content.

FIG. 13C is a graph showing aroma score and aroma intensity plotted against pH.

FIG. 14 is a schematic diagram showing a method of collecting raw feathers and subjecting to treatment as described in Example 7.

FIG. 15 is a schematic diagram showing raw feather treatment plan as described in Example 7.

FIG. 16A is a graph showing changes in pH of unwashed raw feathers stored at ambient temperature over the course of 6 days.

FIG. 16B is a graph showing changes in pH of washed raw feathers stored at ambient temperature over the course of 6 days.

FIG. 16C is a series of graphs comparing changes in pH of unwashed raw feathers stored at ambient versus refrigerated temperatures over the course of 6 days.

FIG. 17 is a graph showing changes in pH of T1-T4 raw feather samples over the course of 15 days.

FIG. 18 is a graph showing pH compared to number of washings of raw feathers, supernatant, and resultant feather meal.

FIG. 19A is a schematic diagram showing an exemplary method of producing feather meal.

FIG. 19B is a schematic diagram showing the tested methods of producing feather meal as described in Example 8.

FIG. 19C is a schematic diagram showing conventional methods of producing feather meal and analytical data of the feather meal made from conventional methods.

FIG. 20 is a table showing aroma descriptors and aroma scores of feather meal produced from washed raw feathers, coarse cut washed raw feathers, and screw pressed washed raw feathers.

FIG. 21 is a table showing aroma descriptors and aroma scores of feather meal produced from washed raw feathers hydrolyzed at 50 psi, 60 psi, and 70 psi.

FIG. 22 is a table showing aroma descriptors and aroma scores of feather meal produced from washed raw feathers hydrolyzed for 10 minutes and 22 minutes.

FIG. 23 is a table showing aroma descriptors and aroma scores of feather meal produced from washed raw feathers with the addition of 10%, 20%, or 30% by weight of defatted rice bran.

FIG. 24 is a table showing aroma descriptors and aroma scores of feather meal produced from unwashed and washed raw feathers with the addition of 15% by weight of defatted rice bran.

### DETAILED DESCRIPTION

The present disclosure provides a food product ingredient formed from a keratinous protein-containing material and methods for producing the same. The present methods include forming a mixture of a keratinous protein-containing material and a cereal bran and subjecting the mixture to hydrolysis to form the food product ingredient. The keratinous protein-containing material is cleaned prior to forming the mixture and undergoing hydrolysis, which advantageously leads to the food product ingredient having improved odor and aroma score. A food product ingredient formed from the methods disclosed herein can be used in food products, such as pet food products.

Previously described methods for hydrolyzing keratinous protein-containing materials resulted in products having noticeable or significant off odors or malodors resulting from the breakdown of the disulfide bonds in the keratinous protein-containing material. It was also believed that the inclusion of ingredients other than the keratinous protein-containing material in the mixture was undesirable. For instance, the presence of cereal bran in the mixture that is subject to hydrolysis was thought to be disadvantageous because any such extraneous material ultimately diluted the protein content of the finished product. Since hydrolyzed keratinous protein-containing materials having a higher protein content are considered to more valuable, dilution of the final protein content of the finished product typically is believed to result in a diminished commercial value.

It has been surprisingly discovered that the cleaning of the keratinous protein-containing material prior to hydrolysis significantly improves the odor of the resultant food product ingredient. Furthermore, it was discovered that even though addition of cereal bran and water may lessen the total protein content in the finished food product ingredient described herein, the aroma quality of the food product ingredient is substantially improved. This benefit may carry forward to food products (e.g., pet food products) that incorporate the food product ingredients. This benefit can be so substantial that the commercial value of the food product ingredients and downstream products is substantially the same, or even increased, relative to the commercial value of conventionally produced food product ingredients, even though the inclusion of an amount of cereal bran and solvent may ultimately result in a lowering of the protein content of the inventive food product ingredients and downstream products incorporating the same.

Various objects and advantages of this process and its compositions will become apparent from the following description taken in conjunction with the accompanying drawings which set forth, by way of illustration and example, certain embodiments of the process and resulting compositions.

### Definitions

The terms used in this specification generally have their ordinary meanings in the art, within the context of this invention and in the specific context where each term is used. Certain terms are discussed below, or elsewhere in the specification, to provide additional guidance to the practitioner in describing the compositions and methods of the invention and how to make and use them.

As used herein, the use of the words “a” or “an” when used in conjunction with the term “comprising” in the claims and/or the specification may mean “one,” but it is also consistent with the meaning of “one or more,” “at least one,” and “one or more than one.” Still further, the terms “having,” “including,” “containing” and “comprising” are interchangeable and one of skill in the art is cognizant that these terms are open ended terms.

The terms “first”, “second”, and the like, as used herein do not denote any order, quantity, or importance, but rather are used to distinguish one element from another.

The terms “about” or “approximately” mean within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 20%, preferably up to 10%, more preferably up to 5%, and more preferably still up to 1% of a given value. Alternatively, particularly with respect to biological systems or processes, the term can mean within an order of magnitude, preferably within 5-fold, and more preferably within 2-fold, of a value. Unless otherwise indicated, all numbers expressing quantities, properties, and so forth used in the specification and claims are to be understood as being modified in all instances by the term “about”. And so, the numerical parameters set forth in this specification and claims are approximations that can vary depending upon the desired properties sought to be obtained by the presently-disclosed subject matter.

Reference throughout the specification to “one example” or “an example” means that a particular feature, structure, or characteristic described in connection with an embodiment or example is included in at least one embodiment. Thus, the appearance of the phrases “in one example” or “in an example” in various places throughout the specification does not necessarily indicate reference to the same embodiment. Further, the particular features, structures or characteristics may be combined in any suitable manner in one or more embodiments. And so, similarly, the phrase “in one embodiment” in various places in the specification are not necessarily referencing the same embodiment, although the inventive concepts disclosed herein are intended to encompass all combinations and permutations including one or more features.

As used herein, the terms “animal” or “pet” mean a domestic animal including, but not limited to, domestic dogs, cats, horses, cows, ferrets, rabbits, pigs, and the like. Domestic dogs and cats are particular examples of pets.

As used interchangeably herein, “aroma” and “smell” refer to an olfactory response to a stimulus. For example, and not by way of limitation, an aroma can be produced by aromatic substances that are perceived by the odor receptors of the olfactory system. The characterization and/or detection of an aroma can be measured, for instance, by using a sensory methodology such as quantitative descriptive analysis (QDA).

As used herein, “food product” refers to an ingestible product, such as, but not limited to, human and animal foods. Food products include pet food products.

The term “food product ingredient” as used herein refers to an ingredient prepared from a keratinous protein-containing material according to any one of the methods disclosed herein that can be used as a component of or in the preparation of a food product. In certain non-limiting examples, the food product ingredient is used in a pet food product.

As used herein, the terms “pet food,” “pet food composition,” or “pet food product” all refer to a composition intended for ingestion by a pet. Pet foods can includes any food, feed, snack, food supplement, liquid, beverage, treat, toy (chewable and/or consumable toys), and meal substitute or meal replacement. Pet foods include dry, wet, and semi-moist pet foods.

The term “keratinous protein-containing material” refers to a material that contains the protein keratin. Keratinous protein-containing materials useful for the methods disclosed herein can be derived from an animal. Exemplary keratinous protein-containing materials include, but are not limited to, feathers, hair, wool, hide, bristles, horns, hooves, claws, nails, and scales.

As used herein, the term “hydrolysis” refers to a chemical reaction involving breaking of a chemical bond in the presence of water. Hydrolysis includes both steam and enzyme hydrolysis, as well as any other method of performing hydrolysis as known in the art. “Steam hydrolysis” refers to a process wherein hydrolysis occurs in the presence of steam. “Enzyme hydrolysis” refers to a process wherein hydrolysis is catalyzed by an enzyme. In the presently disclosed methods, hydrolysis can be used to denature a keratinous protein-containing material, i.e., by breaking disulfide bonds between cysteine residues.

The term “malodor” refers to an unpleasant or offensive odor or smell. Malodors typically result from the presence of sulfur- or nitrogen-containing compounds that are linked to having an unpleasant odor. For example, a malodor in a composition may result from the presence of one or more biogenic amines in the composition. Exemplary biogenic amines that can contribute to the malodor of a composition include, but are not limited to, putrescine, cadaverine, spermine, spermidine, and tyramine.

As used herein, the term “palatability” refers to a food's appeal and acceptability to a subject's (e.g., a pet's) taste and palate. Palatable foods are foods that are appealing and acceptable to a subject. Palatability can be relative, such that some foods are highly palatable, i.e., highly appealing and desirable, whereas other foods are less palatable, i.e., less appealing and desirable. The subject (e.g., the pet) can prefer more palatable foods over less palatable foods.

The presently-disclosed subject matter is illustrated by specific but non-limiting examples throughout this description. The examples may include compilations of data that are representative of data gathered at various times during the course of development and experimentation related to the present invention(s). Each example is provided by way of explanation of the present disclosure and is not a limitation thereon. In fact, it will be apparent to those skilled in the art that various modifications and variations can be made to the teachings of the present disclosure without departing from the scope of the disclosure. For instance, features illustrated or described as part of one embodiment can be used with another embodiment to yield a still further embodiment.

All combinations of method or process steps as used herein can be performed in any order, unless otherwise specified or clearly implied to the contrary by the context in which the referenced combination is made.

Unless defined otherwise, all technical and scientific terms used herein have the same meaning as commonly understood by one of ordinary skill in the art to which the presently-disclosed subject matter belongs.

All ranges recited herein are understood to encompass any and all subranges subsumed therein, inclusive of each endpoint, and every number and combination of numbers therebetween. For example, a stated range of from about 1 to about 10 is considered inclusive of the minimum value of about 1 and the maximum value of about 10, and all subranges beginning with 1 or more (e.g., 1 to 5.4 or 2 to 8.8) and ending with a maximum value of 10 or less (e.g., 2.2 to 5.4, 3.1 to 10, 4.6 to 9.9, etc.) and further inclusive of each number contained within the range, e.g., 1, 2, 3, 4, 5, 6, 7, 8, 9 and 10. All percentages, ratios and proportions herein are by weight unless otherwise specified.

### Food Product Ingredients

Described herein is a food product ingredient formed from a keratinous protein-containing material and a cereal bran. Food product ingredients of the present disclosure are produced according to any of the methods described herein, e.g., by hydrolyzing a mixture including the keratinous protein-containing material and the cereal bran. The keratinous protein-containing material is cleaned prior to forming the mixture. Furthermore, the cereal bran may be mixed with a solvent, e.g., water. The food product ingredient may also optionally include additives, such as antioxidants.

A food product ingredient produced according to the methods of the present disclosure is advantageously characterized by reduced total aroma, reduced malodor, improved odor, and/or improved palatability compared to previous food product ingredients derived from keratinous protein-containing material that are prepared according to methods different from those described herein. For instance, a food product ingredient produced according to the methods disclosed herein can have a total aroma score of less than 5.5 on a scale of 0 to 15 as measured by quantitative descriptive analysis. A food product ingredient as described herein can also have an overall lower content of volatile compounds, e.g., biogenic amines, that contribute to a malodor or unpleasant aroma, as compared to a food product ingredient produced by conventional methods known in the art. The food product ingredient also can include volatile compounds such as methylpyrazine, a byproduct of the Maillard reaction, that contribute to an overall pleasant aroma. The reduced malodor, improved odor, and/or improved palatability of the food product ingredient allows it to be incorporated in greater amounts into a food product or pet food product as compared to other food product ingredients derived from a keratinous protein-containing material that have a comparatively more unpleasant odor and/or less palatability.

Food product ingredients of the present disclosure are stable at ambient temperature during the course of storage, e.g., for up to about 2 months, up to about 4 months, up to about 6 months, up to about 8 months, up to about 10 months, up to about 12 months, or longer. Stability of the food product ingredient can be assessed, e.g., by monitoring the amount of hexanal and peroxide values of the food product ingredient and changes in the amounts over time. For example, in some embodiments, the amount of hexanal of the food product ingredient is less than about 10 ppm, e.g., about 8 ppm, about 5 ppm, about 3 ppm, about 1 ppm, or about 0 ppm during the course of storage. In further embodiments, the peroxide value of the food product ingredient is less than about 10 mEq/kg fat, e.g., about 8 mEq/kg fat, about 5 mEq/kg fat, about 3 mEq/kg fat, about 1 mEq/kg fat, or about 0 mEq/kg fat during the course of storage.

Additionally, a food product ingredient as described herein exhibits from about 85%-95%, e.g., at least about 85%, or at least about 87%, or at least about 89%, or at least about 91%, or at least about 92%, or at least about 93%, or at least about 94%, or at least about 95%, or at least about 96%, or at least about 97%, or at least about 98%, or at least about 99%, or even at least about 99.5% protein digestibility as measured by the 2-step enzymatic method described by Boisen and Fernandez (1995). Furthermore, the food product ingredient contains a variety of amino acids, including, but not limited, to cysteine, leucine, arginine, glutamic acid, glycine, serine, and phenylalanine.

### Keratinous Protein-Containing Material

A food product ingredient produced according to the methods described herein may be formed from any keratinous protein-containing material as known in the art. A keratinous protein-containing material is a material that contains keratin, which is a fibrous structural protein that is found in certain animals. Examples of keratinous protein-containing materials include, but are not limited to, feathers, hair, wool, hide, bristles, horns, hooves, claws, nails, scales, or mixtures thereof. Any other suitable keratinous protein-containing material may also be used to produce a food product ingredient according to the methods disclosed herein. The keratinous protein-containing material may be obtained from a slaughterhouse or another suitable source. Hair and feathers may be also be obtained from living animals that have shed the hair or molted the feathers. According to the present disclosure, the keratinous protein-containing material is cleaned prior to being formed into a food product ingredient.

In the disclosed methods, the keratinous protein-containing material can be used raw. In certain embodiments, for example, a food product ingredient can be made from raw feathers as the keratinous protein-containing material.

Preferably, the keratinous protein-containing material is cleaned and/or frozen within about 5 hours (e.g., within about 5 hours, within about 4 hours, within about 3 hours, within about 2 hours, within about 1 hour, or within about 30 minutes) of collection. The term “collection” refers to the collection of molted feathers or hair that has been shed and/or refers to the collection of the keratinous protein-containing material directly from the animal source. Importantly, cleaning and/or freezing the keratinous protein-containing material contributes to a further minimizing effect on the generation of malodors and/or unpleasant aromas during the hydrolysis process and in the resultant food product ingredient. The keratinous protein-containing material may be cleaned with a cleaning solution.

For instance, the keratinous protein-containing material may be cleaned with water (e.g., tap water), or a solution thereof. The cleaning solution may optionally comprise a solvent or surfactant. If a solvent or surfactant is used, it may be desirable to rinse the protein containing material multiple times after contact with the cleaning solution, or to use a generally recognized as safe (GRAS) solvent.

The cleaning solution can be at ambient (i.e., about 15-25° C.) or elevated temperature. For example, the cleaning solution can be at an elevated temperature of from about 30° C. to about 100° C., from about 30° C. to about 50° C., from about 50° C. to about 70° C., from about 60° C. to about 80° C., from about 70° C. to about 90° C., from about 80° C. to about 100° C., from about 40° C. to about 80° C., or from about 40° C. to about 60° C. The keratinous protein-containing material may be rinsed once or multiple times with the cleaning solution. The keratinous protein-containing material may also be soaked for a period of time in the cleaning solution.

For example, in some embodiments, the keratinous protein-containing material (e.g., raw feathers) is washed with water. The keratinous protein-containing material can be washed at least once, at least twice, or at least three times. In certain embodiments, the keratinous protein-containing material is washed three times. In instances where the keratinous protein-containing material is washed more than once, the keratinous protein-containing material can be washed first with hot water, then washed (e.g., once or twice) with water at ambient temperature, such as tap water. The hot water can be at a temperature of about 180° F. (about 82° C.). Furthermore, the keratinous protein-containing material can optionally be stored at a decreased temperature (e.g., refrigerated or stored on ice) between multiple washes. Preferably, at least the initial wash of the keratinous protein-containing material occurs within about 5 hours, about 4 hours, about 3 hours, about 2 hours, about 1 hour, about 30 minutes, or immediately after collection of the keratinous protein-containing material.

After cleaning, the keratinous protein-containing material can be dewatered by draining, sieving, or the like to remove excess water. Dewatered keratinous protein-containing materials may have, for example, a moisture content of from about 65% to about 80%. Afterwards, the dewatered material is next transferred to a continuous or conveying bin where the material is aerated, agitated, or otherwise decompacted, and conveyed to a contaminant separation station where organic and/or inorganic contaminants are separated from the keratinous protein-containing material to reduce or eliminate damage to subsequent processing equipment or contamination of the processed foodstuff product.

Following cleaning, the keratinous protein-containing material can be stored at a temperature lower than ambient temperature (e.g., on ice or refrigerated) prior to being subject to hydrolysis. In certain non-limiting examples, the keratinous protein-containing material can be stored at a temperature of, e.g., less than about 14° C., less than about 12° C., less than about 10° C., less than about 8° C., less than about 6° C., less than about 4° C., less than about 2° C., less than about 0° C., less than about −2° C., or less than about −4° C. In further non-limiting examples, the keratinous protein-containing material can be stored at a temperature of, e.g., from about 1° C. to about 4° C., from about 3° C. to about 7° C., from about 5° C. to about 8° C., from about 7° C. to about 10° C., from about 9° C. to about 12° C., from about 11° C. to about 14° C., from about 1° C. to about 6° C., from about 4° C. to about 10° C., from about 6° C. to about 12° C., from about 8° C. to about 14° C., from about 2° C. to about 4° C., from about 2° C. to about 8° C., from about 2° C. to about 10° C., from about 2° C. to about 12° C., from about 1° C. to about 10° C., or from about 1° C. to about 12° C. In other non-limiting examples, the keratinous protein-containing material can be stored at a temperature of, e.g., about 14° C., about 12° C., about 10° C., about 8° C., about 6° C., about 4° C., about 2° C., about 0° C., about −2° C., or about −4° C.

### Cereal Bran

The food product ingredient produced according to the methods disclosed herein include a cereal bran. Cereal bran can be added to the keratinous protein-containing material, and may desirably be added prior to any processing steps, upon receipt of the raw material, after any dewatering step, or before or after any contaminant removal step. In certain examples, the cereal bran is added prior to any hydrolysis step. However, the cereal bran may also be added in portions before and after one or more hydrolysis steps of the method. The food product ingredient can include up to about 30 wt. %, up to about 20 wt. %, or up to about 10 wt. % cereal bran. In some embodiments, the food product ingredient desirably includes from about 5 wt. % to about 10 wt. % cereal bran (e.g., about 5 wt %, about 6 wt %, about 7 wt %, about 8 wt %, about 9 wt %, or about 10 wt %), based upon the total weight of the food product ingredient.

Bran from any cereal may be used for the disclosed methods. Exemplary cereal brans that can be used according to the disclosed methods include, but are not limited to, amaranth bran, bulgur bran, farro bran, quinoa bran, spelt bran, teff bran, triticale bran, wild rice bran, wheat bran, corn bran, barley bran, rye bran, millet bran, oat bran, rice bran, sorghum bran, or buckwheat bran. The cereal bran may be defatted, if desired. For instance, in some embodiments, the cereal bran is wheat bran, corn bran, barley bran, or rice bran. In further embodiments, the cereal bran is rice bran, which may or may not be defatted. The use of defatted cereal bran can provide further advantages in that the fat portion of the cereal bran can be separated and used in other products. Those embodiments in which defatted cereal bran is used can thus provide additional economic benefit.

The cereal bran is can be combined with an amount of a solvent, e.g., water, prior to addition to the protein-containing material. Inclusion of a solvent such as water has been found to further reduce any unpleasant odors that would otherwise be produced by the hydrolysis process. The ratio of cereal bran to solvent, e.g., water, can be from about 1 part cereal bran to about 0 parts water (1:0) to about 1 part cereal bran to about 1 part water; or the ratio of cereal bran to solvent, e.g., water, can be from about 80 parts cereal bran to about 20 parts water (80:20) to about 20 parts cereal bran to about 80 parts water (20:80), inclusive of every subrange therebetween. For example, other possible ratios of cereal bran to water include, but are not limited to, about 75:25, about 70:30, about 65:35; about 60:40, about 55:45; and about 50:50. In further examples, the ratio of water to cereal bran can be, e.g., about 75:25, about 70:30, about 65:35; about 60:40, about 55:45; and about 50:50.

The cumulative amount of cereal bran added during the method, in any number of additions, will desirably be no more than about 30%, or no more than about 20%, or no more than about 18%, or no more than about 16%, or no more than about 14%, or no more than about 12%, or no more than about 10%, or no more than about 8%, or no more than about 6%, or no more than about 4%, or no more than about 2% by weight of the total weight of the mixture of keratinous protein-containing material and cereal bran. For example, the cumulative amount of cereal bran is about 0.1%, or about 0.5%, or about 1%, or about 2%, or about 3%, or about 4%, or about 5%, or about 6%, or about 7%, or about 8%, or about 9%, or about 10%, or about 11%, or about 12%, or about 13%, or about 14%, or about 15%, or about 16%, or about 17%, or about 18%, or about 19%, or about 20% by weight of the total weight on a dry matter basis, of the mixture of keratinous protein-containing material and cereal bran. In some instances, the amount of cereal bran in the mixture will be from about 0.1 wt. % to about 20 wt. %, or from about 0.5 wt. % to about 18 wt. %, or from about 1 wt. % to about 16 wt. %, or from about 1 wt. % to about 12 wt. %, or from about 2 wt. % to about 14 wt. %, or from about 3 wt. % to about 12 wt. %, or from about 5 wt. % to about 10 wt. %, or from about 8 wt. % to about 12 wt. %, or from about 5 wt. % to about 15 wt. %, or from about 0.1 wt % to about 5 wt %, or from about 10 wt % to about 20 wt %, or from about 10 wt % to about 16 wt %, or from about 12 wt % to about 18 wt %. In particular embodiments, the cereal bran is rice bran, e.g., defatted rice bran.

### Additives

A food product ingredient as described herein can optionally include an additive, such as an antioxidant. According to the methods disclosed herein, the additive may be added to the keratinous protein-containing material. For example, one or more food grade antioxidants may be added to the keratinous protein-containing material before, during, or after the hydrolysis process. In some embodiments, the antioxidant(s) may be added prior to or during hydrolysis. In other embodiments, the antioxidant(s) may be added after hydrolysis and prior to drying. The inclusion of such antioxidants may assist not only in the further reduction of off odors associated with fat oxidation, but also, has surprisingly been found to render the resulting food product ingredient (and a food product incorporating the same) more palatable.

Examples of food grade antioxidants that may be included in the food product ingredient include any known food grade antioxidant, including, but not necessarily limited to, carotenoids such as beta-carotene, lutein, astaxanthin, zeaxanthin, bixin and lycopene; selenium; coenzyme Q10; lutein; tocotrienols; soy isoflavones; S-adenosylmethionine; glutathione; taurine; N-acetylcystein; vitamin E; vitamin C; vitamin A; lipoic acid; L-carnitine; propyl galate; ascorbyl palmitate; lecithin; tocopherol and mixed tocopherols; polyphenols such as oil of rosemary, rosemary extract, rosemarinic acid, cocoa polyphenols, or polyphenols found in tea or green tea, coffee extract, coffeic acid, turmeric extract, blueberry extract, grapeseed extract; butylated hydroxyanisole (BHA), tertiary butylhydroquinone (TBHQ), butylated hydroxytoluene (BHT), compounds containing one or more phenolic groups, carboxyl groups, lactone rings and/or isoprene units, or combinations of these. Examples of commercially available antioxidants acceptable for use in food include PET-OX® Premium Liquid (Kemin Industries, Des Moines, Iowa) and NATUROX® Liquid (Kemin Industries, Des Moines, Iowa).

If desired, one or more food grade antioxidants may be included the food product ingredient in amounts according to food and feed regulations, e.g., in amounts of from about 100 ppm to about 10000 ppm (e.g., about 100 ppm, about 500 ppm, about 1000 ppm, about 2500 ppm, about 5000 ppm, about 7500 ppm, or about 10000 ppm) on a dry matter basis, or from about 0.01 wt. % to about 1.0 wt. % (e.g., about 0.01 wt %, about 0.05 wt %, about 0.1 wt %, about 0.25 wt %, about 0.5 wt %, about 0.75 wt %, or about 1.0 wt %) based upon total weight of the food product ingredient.

### Methods for Producing a Food Product Ingredient

The present disclosure provides methods for producing a food product ingredient as described herein. According to the disclosed methods, a keratinous protein-containing is cleaned with a cleaning solution, then combined with a cereal bran to form a mixture. Optionally, the cereal bran is combined with a solvent (e.g., water) prior to forming the mixture. The mixture is then subjected to one or more hydrolysis steps, e.g., steam hydrolysis or enzyme hydrolysis. The mixture is optionally subjected to pre-processing prior to forming the mixture and/or intermediate processing after the mixture is formed but prior to hydrolysis. Following hydrolysis, the keratinous protein-containing material can undergo further processing to be formed into a food product or food product ingredient.

### Pre- and Intermediate Processing

Any of the methods disclosed herein can optionally include a pre-processing step, which is performed prior to the forming of the mixture of the keratinous protein-containing material and the cereal bran. Pre-processing includes subjecting the keratinous protein-containing material to one or more pre-processing steps, such as removal of any organic or inorganic contaminants, wetting, de-watering, sieving, rinsing, size reduction, or addition of proteolytic enzymes or reducing agents. In some examples, the pre-processing step includes size reduction of the keratinous protein-containing material. The keratinous protein-containing material can be, for instance, coarse cut or screw pressed. In further examples, the pre-processing includes a pretreatment step, wherein the keratinous protein-containing material is pretreated with a proteolytic enzyme and/or a suitable reducing agent prior to hydrolysis. It is expected that pretreatment helps to facilitate hydrolysis of the keratinous protein-containing material. For example, a food-grade reducing chemical, such as sodium metabisulfite, may be added to the keratinous protein-containing material. The proteolytic enzyme and/or reducing agent of the pretreatment step may also be added to the mixture comprising the cereal bran and the keratinous protein-containing material to facilitate hydrolysis.

Any of the methods disclosed herein may also optionally include an intermediate processing step, which is performed after the mixture of the keratinous protein-containing material and the cereal bran is formed but prior to hydrolysis. Intermediate processing steps include removal of any organic or inorganic contaminants, wetting, rinsing, size reduction, addition of proteolytic enzymes or reducing agents, etc.

Pre- and/or intermediate processing can be included as a step in any embodiment of the methods disclosed herein. In some embodiments, the method only includes pre-processing. In some embodiments, the method only includes intermediate processing. In further embodiments, the method includes both pre-processing and intermediate processing.

### Hydrolysis

In the methods disclosed herein, the mixture comprising the cereal bran and the keratinous protein-containing material is subjected to hydrolysis under conditions sufficient to hydrolyze the protein-containing material therein, i.e., to break the disulfide bonds and denature the keratin protein. Any suitable type of hydrolysis may be performed, including steam, enzyme, and/or chemical hydrolysis. Hydrolysis can occur in one step or multiple steps. Multiple hydrolysis steps are desirable in some instances in order to further enhance or maximize the digestibility of the final hydrolysate. If multiple hydrolysis steps are performed, each hydrolysis step can be performed using the same or different types of hydrolysis processes.

In some embodiments, the method includes one hydrolysis step, e.g., steam hydrolysis, enzyme hydrolysis, or chemical hydrolysis. In further embodiments, the method includes multiple steam hydrolysis steps, multiple enzyme hydrolysis steps, multiple chemical hydrolysis steps, or a combination thereof. The multiple hydrolysis steps can employ the same type of hydrolysis processes or different types of hydrolysis processes selected from any one of the hydrolysis methods disclosed herein or otherwise known in the art. Variations of the same hydrolysis process may also be used in a method including multiple hydrolysis steps of the same type of hydrolysis process. Variations in the processes may include variations in the conditions, such as variations in the retention times, pressures, temperatures, types of enzymes used, or any combination of thereof

Steam Hydrolysis

In some embodiments, the methods disclosed herein employ steam hydrolysis as the method of hydrolysis. In other embodiments, the methods disclosed herein employ steam hydrolysis as one of the methods of hydrolysis. Suitable steam hydrolysis conditions use saturated steam at an elevated pressure and corresponding elevated temperatures, which may be determined based on known saturated steam properties. Heat may be supplied in indirect form through a high pressure vessel jacket, or it may be directly provided by steam heating. In some embodiments, the pressure at which steam hydrolysis is performed is from about 1 bar or 14.7 psig to about 4 bars or 58.8 psig. In further embodiments, the pressure at which steam hydrolysis is performed is from about 50 psi to about 70 psi, or from about 40 to about 60 psi, or from about 60 to about 80 psi, or from about 40 to about 80 psi. For example, steam hydrolysis of the keratinous protein-containing material is performed at about 60 psi.

The keratinous protein-containing material and cereal bran mixture is subjected to steam hydrolysis for a predetermined period of time to achieve a desired level of digestibility. For example, the keratinous protein-containing material is subjected to steam hydrolysis for a time period of from about 15 minutes to about 30 minutes, or from about 20 minutes to about 50 minutes, from about 15 minutes to about 60 minutes, or from about 15 minutes to about 90 minutes, or from about 15 minutes to about 120 minutes, or from about 15 minutes to about 150 minutes, or from about 15 minutes to about 180 minutes, or from about 15 minutes to about 210 minutes, or from about 15 minutes to about 240 minutes. In certain embodiments, the keratinous protein-containing material is subjected to steam hydrolysis for a time period of, e.g., about 10 minutes, about 15 minutes, about 20 minutes, about 25 minutes, or about 30 minutes. For example, the keratinous protein-containing material is subjected to steam hydrolysis for 22 minutes.

The keratinous protein-containing material/cereal bran mixture may be agitated during steam hydrolysis, such as by shaking or stirring. Stirring may be employed to provide substantially continuous mixing, which facilitates penetration of the pressurized steam to achieve even heat throughout the mixture. Hydrolysis of the mixture may be accomplished using a continuous operation steam pressure hydrolyser system or a batch process type system. Once hydrolysis has been performed in accordance with predetermined pressure, temperature and time parameters, the mixture is discharged into an expansion tank where pressure and excess moisture are released. This generally brings the temperature of the mixture down to about 208-216° F., e.g., about 212° F. Preferably, the cooled mixture has a retained moisture content from about 40% to about 75% (e.g., about 40%, about 50%, about 60%, about 70%, or about 75%).

Enzyme Hydrolysis

In further embodiments, the method disclosed herein employs enzyme hydrolysis as the primary method, or one of several methods of hydrolysis. Enzyme hydrolysis can be carried out using any proteolytic enzyme known in the art, including but not limited to, proteases, such as endoproteases and exoproteases; exogenous enzymes; endogenous enzymes; or combinations thereof.

For example, the enzyme hydrolysis may include the use of an endoprotease. Endoproteases, such as keratinase and papain, may be used either alone or in combination with another enzyme, such as another protease. Use of a combination of proteases may synergistically hydrolyze the keratin, further improving the efficiency of the process.

In another example, the enzyme hydrolysis may include the use of an exoprotease. Exoproteases may also be used in whole or as part of any enzyme hydrolysis to further reduce protein size, to generate peptides of desired characteristics, and/or to produce hypoallergenic and/or anallergenic protein ingredients. Any suitable enzyme products containing purified exoproteases, e.g., FLAVOURZYME® (Novo Nordisk, Bagsvaerd, Denmark) and VALIDASE® FP (DSM, Heerland, Netherlands) may be employed.

Alternatively, endogenous enzymes carried in raw material may be used to reduce the required dosages of added endoproteases. These may be obtained from animal viscera and can include, for example, proteases, carbohydrases and/or lipases.

The enzymatic hydrolysis conditions are selected to produce optimum results, and are dependent on the enzymes employed. Agitation rate, moisture content, pH, and temperature are selected in accordance with selected enzyme(s), and incubation conditions are tailored to achieve optimum results. Higher hydrolysis temperatures may be employed where they increase the conversion rate without generating unwanted products, such as the antinutrients lysinoalanine and lanthionine.

Duration of the enzymatic hydrolysis step is dependent on the starting material as well as the desired end product, but may last up to about 6 hours and preferably from about 30 minutes to about 6 hours. In order to maintain the commercial viability of the process, in certain preferred embodiments hydrolysis time is limited to less than about 4 hours. In certain particularly preferred embodiments, the hydrolysis time may range from about 2 hours to about 3 hours. In other embodiments, the hydrolysis time may be from about 30 minutes to about 2 hours.

### Further Processing

After hydrolysis, the hydrolyzed mixture can be further processed according to conventional hydrolysis processes. This can include subjecting the material to one or more of drying, sifting, milling, comminuting, concentrating, refrigerating, freezing, pasteurizing, acidifying, centrifugation, filtration and/or ultrafiltration, and/or decanting. For example, the hydrolyzed mixture is directly dried. It is understood that this list is not exhaustive and further understood that not all further processing steps need to be performed in every embodiment of the method.

For example, the hydrolyzed mixture may be transferred to a dryer feeder for supply to a dryer unit for moisture removal to form a dried food product ingredient and to render the product stable at ambient temperature and storage conditions. The dried food product ingredient may suitably have a moisture content of below about 10%, preferably of about 7.5% by weight. Any suitable type of dryer may be employed, such as a disc dryer or flash dryer. Dryer temperature and exposure time should be minimized to prevent darkening and decreased digestibility. Other drying technology known in the industry may also be used, either alone or in combination, including, but not limited to, spray drying or fluidized layer drying. One step gentle mill drying is one example of a particularly advantageous drying method. In another example, a small Z blade mixer is used as the dryer.

The mixture may next be sifted and transferred to an accumulation or holding bin. If desired, the material may be subject to further milling or comminuting, or be subjected to additional contaminant removal techniques, such as magnetic metal separation via high intensity magnet bars or rods. The mixture is next transferred to cooling and dry bulk storage to await use.

As may be desirable for some end use applications, the keratinous protein-containing material, the mixture of the cereal bran and the keratinous protein-containing material, and/or the hydrolyzed mixture may be subjected to one or more size reduction steps, before, during, or after any step of the process. Size reduction may be performed under wet conditions, dry conditions or any other conditions suitable to effect a size reduction. Any such size reduction may be completed in a single or multiple pass operation, which may include one, two, three, four, or any number of size reduction steps, to achieve a desired average particle size, or a desired D90, e.g., such as below about 400 μm.

### Exemplary Methods

Described below are exemplary embodiments of the methods disclosed herein.

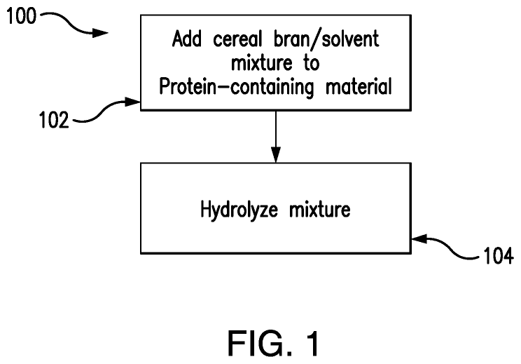

One embodiment of the method is shown in FIG. 1. As shown, method 100 generally involves adding 102 an amount of a first mixture consisting of a cereal bran, e.g., rice bran in a solvent, e.g., water, to a quantity of a keratinous protein-containing material, e.g., feathers, to provide a mixture. The mixture is then hydrolyzed 104, e.g., using steam hydrolysis.

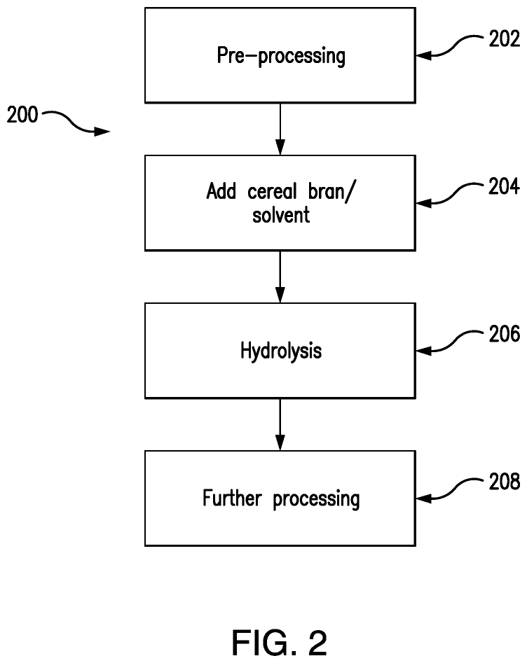

FIG. 2 illustrates a further embodiment of the method. In method 200, the keratinous protein-containing material may be subjected to one or more pre-processing steps 202, such as removal of any organic or inorganic contaminants, wetting, de-watering, sieving, rinsing, size reduction, or addition of proteolytic enzymes or reducing agents. Desirably, the keratinous protein containing material is cleaned at step 202 by washing, rinsing, or soaking the keratinous protein-containing material in water or a GRAS solvent at an elevated temperature. A mixture of a cereal bran (e.g., amaranth bran, bulgur bran, farro bran, quinoa bran, spelt bran, teff bran, triticale bran, wild rice bran, wheat bran, corn bran, barley bran, rye bran, millet bran, oat bran, rice bran, sorghum bran, or buckwheat bran) and a solvent is added 204 to the keratinous protein-containing material. The amount of cereal bran suitable for the disclosed method range from 0.1 wt. % to 20 wt. %, or from 1 wt. % to 15 wt. %, or from 5 wt. % to 10 wt. %, based upon the total weight of the mixture of keratinous protein-containing material and cereal bran.

The keratinous protein-containing material and cereal bran mixture is then hydrolyzed 206. The hydrolysis can be performed according any hydrolysis process including, but not limited to, steam hydrolysis, chemical hydrolysis, enzymatic hydrolysis, or a combination thereof. Hydrolysis can be performed as one step or as multiple steps. If multiple hydrolysis steps are employed, each hydrolysis step can use the same hydrolysis process, different hydrolysis processes, or the same hydrolysis process but under different conditions. For instance, a combination of enzymatic and steam hydrolysis may be used. In another example, the hydrolysis process is the same, but is varied by using different enzymes, different pressures, different temperatures, different retention times, or other hydrolysis reaction conditions.

The hydrolyzed feathers are then subjected to further processing 208. For example, the hydrolyzed feathers can be subjected to one or more size reduction processes, dried, sifted, and accumulated prior to milling and being placed in dry bulk storage, or they may be concentrated, refrigerated, frozen, pasteurized, acidified and/or subjected to further hydrolysis.

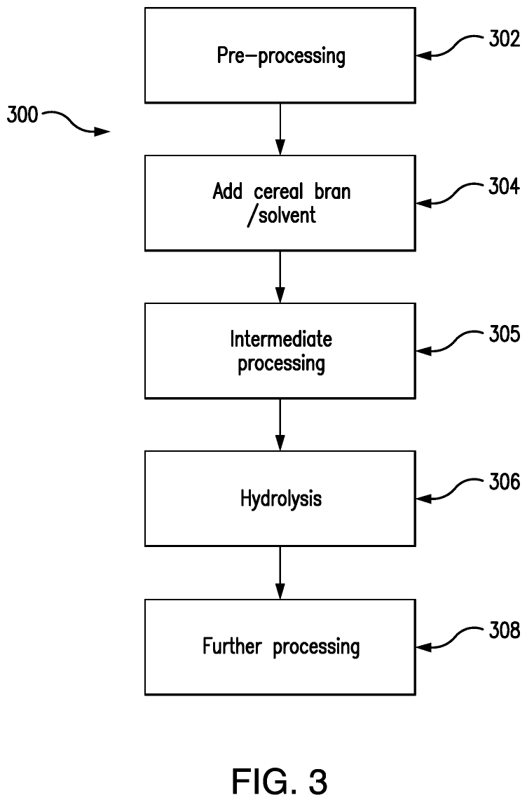

FIG. 3 shows yet another embodiment of the method 300, wherein one or more intermediate processing steps 305 is performed between the addition of the cereal bran/solvent mixture 304 and hydrolysis 306. Intermediate processing steps 305 may include removal of any organic or inorganic contaminants, wetting, rinsing, size reduction, addition of proteolytic enzymes or reducing agents, etc.

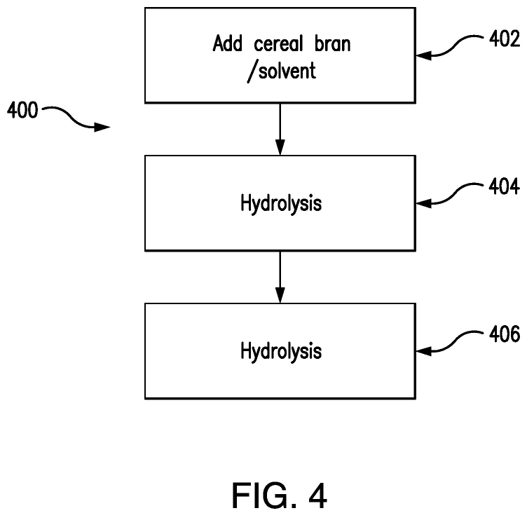

As shown in FIG. 4, another alternate method 400 involves the steps of adding 402 a first mixture consisting of cereal bran and a solvent to a keratinous protein-containing material, then subjecting the mixture to a first hydrolysis step 404, then a second hydrolysis step 406. The hydrolysis processes 404 and 406 may use the same hydrolysis process, different hydrolysis processes, or variations of the same hydrolysis process. Variations in the processes may include variations in the conditions including retention times, pressures, temperatures, variations in the types of enzymes, or any combination of these variations. The hydrolyzed mixture can then again be subjected to a contaminant removal step, wherein any foreign materials are separated using X-ray or other suitable sorting means. Removal of such inclusions serves to prevent damage to cutting head equipment as well as contamination of the feedstock product.

### Food Products

A food product ingredient produced by any of the methods described herein may be incorporated into any end use food product. Particular advantage may be found in the incorporation of the food product ingredient into animal feeds, where high volume, and yet readily available, economical, nutritious, highly digestible, and palatable protein sources are sought after. As the food product ingredients produced from a keratinous protein-containing material according to the methods disclosed herein have less off odorants compared to previously described methods of producing a food product ingredient from keratinous protein-containing material, a larger amount of the food product ingredient described herein can be used as compared to contexts in which the disclosed methods are not used.

The food product ingredient can be incorporated into a food product (e.g., a pet food product, such as a wet, semi-moist, or dry pet food) in amounts of up to about 25 wt. %, or up to about 20 wt. %, or up to about 15 wt. %, or up to about 10 wt. %, based upon the total weight of the food product. For instance, at least about 1 wt. % of the food product ingredient is incorporated into a food product (e.g., a pet food product, such as a wet, semi-moist, or dry pet food). In further embodiments, at least about 5 wt. % of the food product ingredient is incorporated into a food product (e.g., a pet food product, such as a wet, semi-moist, or dry pet food). Acceptable ranges for the amounts of the food product ingredient present in a food product (e.g., a pet food product, such as a wet, semi-moist, or dry pet food) include, but are not limited to, from about 1 wt. % to about 25 wt. %, or from about 1 wt % to about 15 wt %, or from about 5 wt. % to about 20 wt. %, or from about 10 wt. % to about 15 wt. %, or from about 15 wt % to about 25 wt %. The weight percentages provided herein are based upon the total weight of the food product ingredient intermediate mixture, food product ingredient, or food product, as the case may be, and are calculated on a dry matter basis.

### Pet Food Products

For example, the food product ingredient can be incorporated into a pet food product. A pet food product including a food product ingredient as described herein, can be, for example, a dry, wet, or semi-moist pet food. A dry pet food composition can be a pet food having a moisture content of less than 15%, e.g., a moisture content ranging from 1% to 15%, e.g., about 10%, or about 12%. A wet pet food composition includes a pet food having a moisture content of more than 50%, e.g., a moisture content ranging from about 50% to about 90% or more. As used herein, the term “semi-moist” pet food composition refers to a pet food having a moisture content ranging from more than 15% to 50%. Dry, wet, or semi-moist pet foods can be produced according to any methods of producing pet food as known to one of ordinary skill in the art.

An advantage of using the food product ingredient disclosed herein in a pet food product is that the food product ingredient can be incorporated into wet animal feeds, fish food, or pet foods that may typically emit off odorants or unpleasant odors when conventionally produced. The use of the food product ingredient produced according to the methods disclosed in food products generally associated with a perceived malodor may not add to the perception of the malodor consumers, unlike when conventionally processed keratinous protein-containing materials are incorporated into such products. In fact, the food product ingredients and food products incorporating the same are expected to enjoy commercial acceptance and success, even though their total protein content may be less than food product ingredients produced from keratinous protein-containing materials conventionally.

### EXAMPLES

The following examples describe embodiments wherein the keratinous protein-containing material comprised raw feathers and/or raw feather hydrolysate. However, the methods are not so limited and can be applied to any keratinous protein-containing material, without limitation.

### Example 1. Preparation of Feather Meal

Sample Preparation

Raw feathers were collected and a portion thereof subjected to cleaning by washing with tap water within 5 hours of collection. A second portion was used “as is” as the control sample identified by Sample ID FM-RRF. To produce the cleaned feathers, the raw feathers were collected and frozen within 5 hours of collection. 60 kg of frozen feathers were then thawed in a temperature of 40° F. and then washed with tap water at a temperature of 60° C. in a Z blade mixer for 10 minutes, and then rinsed with tap water at a temperature of 60° C. for 10 minutes. The washed feathers were drained and/or dried to a moisture content of about 70%. The thus cleaned feathers were divided into two portions—a first inventive sample to which cereal bran and a solvent are added (Sample ID FM-DRB) and a second, comparative sample that is subject to hydrolysis without addition of cereal bran and solvent (Sample ID FM-CRF).

Each sample was subjected to steam hydrolysis in a Littleford Day Steam Hydrolyzer (model DVT 130, 130 liter size). The raw feathers control sample (Sample ID FM-RRF) and the cleaned feathers sample (Sample ID FM-CRF) were used “as-is” with no solvent or cereal bran added thereto. For the inventive sample (Sample ID FM DRB), defatted rice bran and water were added to the hydrolyzer. For the hydrolysis, the pressure jacket was maintained at a pressure of from 62 to 65 psi and the pressure vessel was maintained at a pressure of 50 psi for a cooking time of 22 minutes. After hydrolysis, the hydrolyzed material was subjected to a size reduction step using a 140 blade microcut heat and then dried at an exhaust temperature between 200 and 210° F. The food product ingredient was dried and subjected to compositional analysis, the results of which are shown in Table 1 below.

TABLE 1
Food Product Ingredient Analytical Data

| Sample ID | FM-RRF | FM-CRF | FM-DRB |
|---|---|---|---|
| pH at 80% Moisture | 5.7 | 6.2 | 6.2 |
| Boisen Avg (%) | 83.4 | 83.3 | 86.8 |
| Protein N x 6.25 (%) | 84.6 | 87.5 | 76.7 |
| Fat Ether (%) | 9.6 | 6.9 | 4.6 |
| Moisture (%) | 6.5 | 6.9 | 6.9 |
| Ash (%) | 0.7 | 0.6 | 2.8 |
| Crude fiber (%) | 0.3 | 0.3 | 2.3 |
| Total Dietary Fiber (%) | | | 6.4 |
| Insoluble Fiber (%) | | | 5.6 |
| Soluble Fiber (%) | | | 0.8 |
| Total Starch (%) | | | 2.8 |
| bulk density g/L | 293 | 275 | 304 |
| Putrescin mg/Kg | 233 | 25 | 22 |
| Cadaverin mg/Kg | 195 | 34 | 28 |
| Histamine mg/Kg | 6 | <2 | <2 |
| Biogenic Amine Index | 39.4 | 5.5 | 3.5 |
| Hexanal mg/kg | 13 | 19 | 5 |
| Peroxyde Value mEq/kg | 3.2 | 5 | Insufficient |
| | | | fats |
| Rapid PV | 2.6 | 3.6 | 0 |
| Free fatty acid % | 60.1 | 34.9 | 32.4 |
| Tryptophan % | 0.66 | 0.7 | 0.62 |
| Cystine % | 4.27 | 4.56 | 3.76 |
| Methionine mg/kg | 5322 | 4989 | 4879 |
| Alanine % | 3.77 | 3.97 | 3.6 |
| Arginine % | 5.95 | 6.42 | 5.67 |
| Aspartic Acid % | 5.56 | 5.86 | 5.32 |
| Glutamic Acid % | 9.49 | 10.09 | 9.65 |
| Glycine % | 6.51 | 6.89 | 6.02 |
| Histidine % | 0.54 | 0.57 | 0.54 |
| Isoleucine % | 4.21 | 4.54 | 3.99 |
| Leucine % | 7.09 | 7.59 | 6.68 |
| Phenylalanine % | 4.15 | 4.46 | 3.87 |
| Proline % | 9.01 | 9.94 | 8.17 |
| Serine % | 10.15 | 10.94 | 9.29 |
| Threonine % | 4.16 | 4.43 | 3.86 |
| Lysine % | 1.61 | 1.49 | 1.55 |
| Tyrosine % | 2.46 | 2.5 | 2.12 |
| Valine % | 6.43 | 6.86 | 6.17 |
| Lanthionine % | 1.57 | 2.00 | 1.50 |

### Example 2. Quantitative Descriptive Analysis of Feather Meal

Feather meal can be a useful source of protein in foods and feeds, but feather meal processing can create undesirable aromas that limit the use of feather meal. Aroma characterization and detection can be reliably and reproducibly measured using sensory methodologies including quantitative descriptive analysis (QDA). QDA uses trained judges who align on a common vocabulary to characterize the aroma attributes of the samples of interest. Once the attributes are selected and agreed, standards are used to anchor and standardize each judge's measurement of the various attributes. Duplicate measurements on samples presented in monadic-sequential order (one at a time, one after the other) create a robust data set that can then be subjected to statistical analysis to arrive at an aroma profile that does or does not distinguish the samples from each other. Using this methodology, feather meal researchers can learn what treatments improve the aroma profile of feather meal.

To constitute an improvement in aroma profile, reduced levels of objectionable aroma attributes and increased levels of desirable aroma attributes should be observed. An overall lower level of aroma than control materials is also desirable. With a lower overall aroma, increased levels of desirable attributes, and reduced levels of objectionable attributes, finished pet food products made with the feather meal are expected to have appealing taste profiles that delight both pets and their owners.

The following quantitative sensory technique provided in Table 2 was used to evaluate feather meal samples according to the invention:

TABLE 2
Quantitative Sensory Technique for Evaluation

| | | |
|---|---|---|
| AROMA ATTRIBUTE | DEFINITION | REFERENCE |

Desirable aroma attributes:

| | | |
|---|---|---|
| Sawdust | The degree to which the | Sawdust |
| | aroma of the product is | |
| | reminiscent of sawdust. | |
| Grain | The degree to which the | Cheerios |
| | aroma of the product is | |
| | reminiscent of grains | |
| | including Cheerios, oats, | |
| | starch, wheat and rice. | |
| Hay | The degree to which the | Alfalfa Hay |
| | aroma of the product is | |
| | reminiscent of hay. | |
| Hydrolyzed | The aroma intensity of | HVP |
| Vegetable | notes associated with | |
| Protein (HVP) | soy, HVP, or warmed | |
| | over meat. | |
| Savory/Broth | The total aroma | Trader Joe's |
| Aromatic | intensity of savory or | Savory Broth |
| | brothy notes, including | Liquid |
| | meat or vegetable broth. | Concentrates |
| Meaty | The aroma intensity of | Bacon Bits |
| | meaty notes in the | |
| | sample, including liver, | |
| | chicken/turkey etc. | |
| Pork Rind/ | The degree to which the | Mission |
| Pig Skin | aroma of the product is | Chicharrones |
| | reminiscent of pork | Pork Rinds |
| | rinds/pig skin. | |

Objectionable Aroma Attributes:

| | | |
|---|---|---|
| Fecal/ | The degree to which the | Chicken and |
| Barnyard | aroma of the product is | Quail coop |
| | reminiscent of chicken | Cadet Bull |
| | coop/bird cage, | Stick |
| | fertilisers and barn | (in the bag) |
| | animals. | |
| Fishy | The degree to which the | Fish food |
| | aroma is soured or | Fish sauce |
| | reminiscent of stale | |
| | urine. | |
| Sulfur | The aroma intensity of | Burnt Match |
| | notes reminiscent of | |
| | fish, such as fish food, | |
| Yeasty | Canned anchovies, tuna, | Brewers Yeast |
| | etc. | Bakers Yeast |

Facility: The evaluation was conducted in a sensory test facility with individually partitioned booths, designed to minimize visual contact between subjects.

Orientation of panelists: Ten trained panelists participated in a two hour orientation session during which they were presented with the above reference materials, definitions and scoresheet to discuss in order to familiarize themselves with the aroma attributes and the scoresheets.

Evaluation of test samples: Evaluation of test samples was performed by providing orientated panelists with 10 g samples in clear, lidded 2 oz cups coded with random 3 digit numbers. Each panelist evaluated six samples in a two hour session (with a 15 minute break in the middle). Each panelist made two evaluations for each sample, so a total of 20 results were obtained for each sample. The samples were provided to the panelists in a monadic-sequential manner (one at a time, one after the other) and the provision of samples was blinded and randomized to ensure the products were seen approximately an equal number of times in each possible position order.

For each sample, the panelists each recorded the intensity of each aromatic attribute on the scoresheet by placing a mark on the 15 point scale. The 15 point scale encompassed the reference materials and evaluation samples together, rather than the evaluation samples alone. The marks were then converted to numbers from 0 to 15 and mean intensities were calculated for each attribute and recorded in a Means Table.

The variance and Tukey's HSD Test (95% confidence level) were used to determine significant differences between the samples for each attribute. When a significant difference between samples was observed it was noted in the Means Table using capital letters, wherein A denotes the largest difference, B the next largest difference and so on.

Results

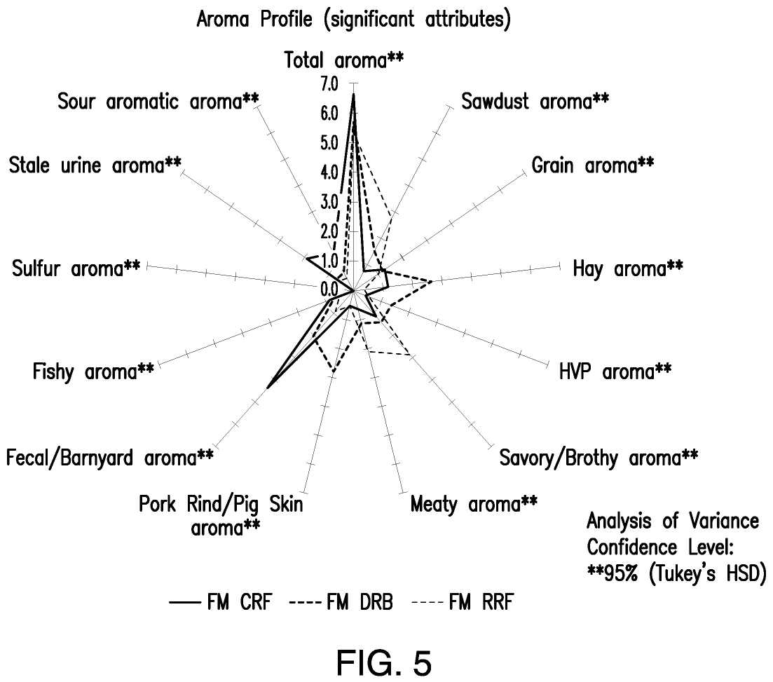

The spider chart of FIG. 5 shows the significant differences between the samples observed in the study. In particular, it shows that the inventive sample using defatted rice bran (FM DRB) with added water has a desirably low total aroma, with higher levels of the desirable attributes Savory/Brothy and Meaty, while also having lower levels of undesirable attributes Fecal/Barnyard and Fishy. The defatted rice bran sample is statistically significantly different from the control sample. These results match the feeding test results where the cat and dog foods with the defatted rice bran feather meal sample was significantly preferred to the control as described below.

TABLE 3
Quantitative Descriptive Evaluations of Feather Meal

| | No Rice | | | |
|---|---|---|---|---|
| | Bran, cleaned | Defatted | Raw | |
| | feathers | Rice Bran | Feathers | |
| | (FM-CRF, | (FM-DRB, | (FM-RRF | |
| AROMA: | comparative) | inventive) | comparative) | Pr > F |
| Total Aroma | 5.72 B | 5.40 C | 6.62 A | <.0001 |
| Sawdust | 1.42 B | 2.73 A | 0.71 C | <.0001 |
| Grain | 1.12 AB | 0.96 B | 1.26 A | 0.0356 |
| Hay | 2.66 A | 0.37 C | 1.14 B | <.0001 |
| HVP | 1.32 A | 0.54 B | 0.42 B | <.0001 |
| (Hydrolyzed | | | | |
| Vegetable | | | | |
| Protein) | | | | |
| Savory/Brothy | 1.36 B | 2.83 A | 1.17 B | <.0001 |
| Meaty | 1.11 B | 2.09 A | 0.63 C | <.0001 |
| Pork Rind/ | 2.77 A | 0.48 B | 0.51 B | <.0001 |
| Pig Skin | | | | |
| Fecal/Barnyard | 2.02 B | 0.88 C | 4.31 A | <.0001 |
| Fishy | 0.70 A | 0.48 B | 0.87 A | 0.0003 |
| Sulfur | 0.01 B | 0.20 A | 0.01 B | 0.0065 |
| Yeasty | 0.17 | 0.16 | 0.16 | 0.9247 |
| Stale Urine | 0.68 B | 0.59 B | 1.95 A | <.0001 |
| Sour Aromatic | 0.70 B | 0.50 B | 1.44 A | <.0001 |

n=20 (10 Panelists, 2 Evaluations Each)
For a specific question (row), values not sharing an uppercase letter are significantly different at the 95% confidence level (Tukey's HSD, p<0.05). Rows without letters indicate no significant difference. Scale range=0 to 15.

As can be seen, the inventive sample had a statistically significant lower overall total aroma, and statistically significant greater scores in the positive attributes of sawdust, savory/brothy and meaty, and statistically significant lower scores in the objectionable/undesirable attributes of fecal/barnyard, fishy and sour aromatic than the comparative samples.

### Example 3. Feeding Studies with Feather Meal

Pet foods for both cats and dogs were prepared incorporating the food product ingredient of Examples 1 and 2 according to the following compositions:

TABLE 4
Exemplary Pet Foods

| | ULP9537 | ULP9538 | ULP9536 |
|---|---|---|---|
| | (dog) and | (dog) and | (dog) and |
| | ULP9540 | ULP9541 | ULP9539 |
| Pet Food sample ID | (cat) | (cat) | (cat) |
| Food product ingredient | FM-RRF | FM-CRF | FM-DRB |
| sample ID | | | |
| Protein N x 6.25 | 31.5 | 31.3 | 33.2 |
| (Rep 1) (%) | | | |
| Fat Ether (Rep 1) (%) | 14.59 | 14.49 | 13.87 |
| Moisture (Rep 2) (%) | 7.15 | 7.42 | 5.52 |
| Ash (Rep 2) (%) | 5.3 | 5.2 | 5.5 |
| Crude fiber (Rep 2) (%) | 1.5 | 1.7 | 1.8 |
| Gel ratio (%) | 95.8 | 94.5 | 93.9 |
| Aw | 0.42 | 0.43 | 0.278 |
| Total Dietary Fiber (%) | 9.9 | 8.1 | 7.9 |
| Insoluble Fiber (%) | 9 | 7.5 | 7.7 |
| Soluble Fiber (%) | 0.9 | 0.6 | 0.2 |
| Total Starch (%) | 35.1 | 31.8 | 34.5 |
| Hexanal mg/kg (Mars | | | |
| method) | 25 | 20 | 19 |
| Peroxyde Value mEq/kg | 19.4 | 26.9 | 19 |
| bulk density g/L | 388 | 411 | 420 |
| Tryptophan % | 0.4 | 0.35 | 0.38 |
| Cystine % | 0.74 | 0.72 | 0.78 |
| Methionine mg/kg | 6642 | 6746 | 6871 |
| Alanine % | 1.78 | 1.83 | 1.89 |
| Arginine % | 1.95 | 2.01 | 2.1 |
| Aspartic Acid % | 2.55 | 2.61 | 2.7 |
| Glutamic acid % | 4.35 | 4.43 | 4.62 |
| Glycine % | 1.86 | 1.88 | 1.99 |
| Histidine % | 0.68 | 0.68 | 0.69 |
| Isoleucine % | 1.44 | 1.47 | 1.54 |
| Leucine % | 2.69 | 2.75 | 2.87 |
| Phenylalanine % | 1.38 | 1.41 | 1.49 |
| Proline % | 2.1 | 2.19 | 2.28 |
| serine % | 1.9 | 2.02 | 2.2 |
| Threonine % | 1.38 | 1.45 | 1.52 |
| Total Lysine % | 1.88 | 1.93 | 1.89 |
| Tyrosine % | 0.88 | 0.94 | 0.97 |
| Valine % | 1.79 | 1.8 | 1.93 |

In feeding studies with both dogs and cats, the pet foods including the food product ingredient prepared as disclosed herein using cereal bran and a solvent were preferred over pet foods including either control pet food product.

### Example 4. Low Oxidation Rate in the Presence of Defatted Rice Bran

Feather meal was produced from regular raw feathers (RRF), cleaned raw feathers (CRF), and cleaned raw feathers in the presence on defatted rice bran (DRB). The feather meal was analyzed for oxidation when stored at ambient temperature without any temperature control. The oxidation was tested at time 0, at 8 months, and at 12 months.

The industry standards for the amount of hexanal and peroxide value (PV) in poultry meal are hexenal <10 ppm and PV<10 meq/kg fat.

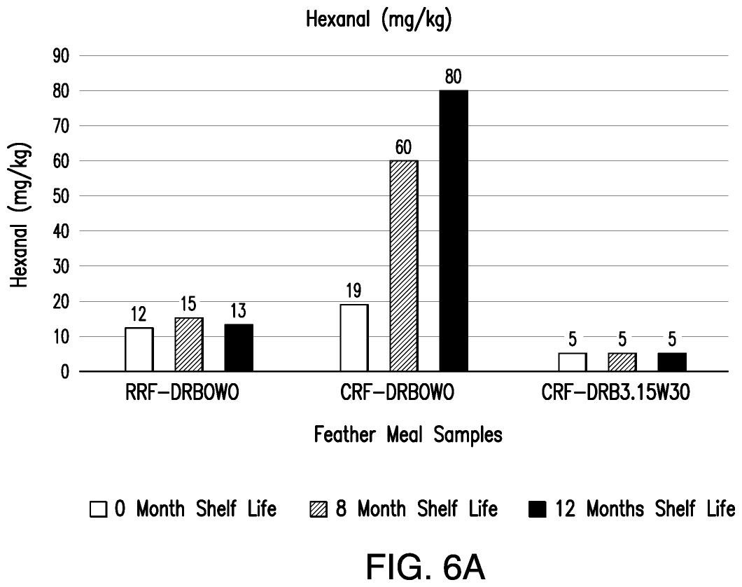

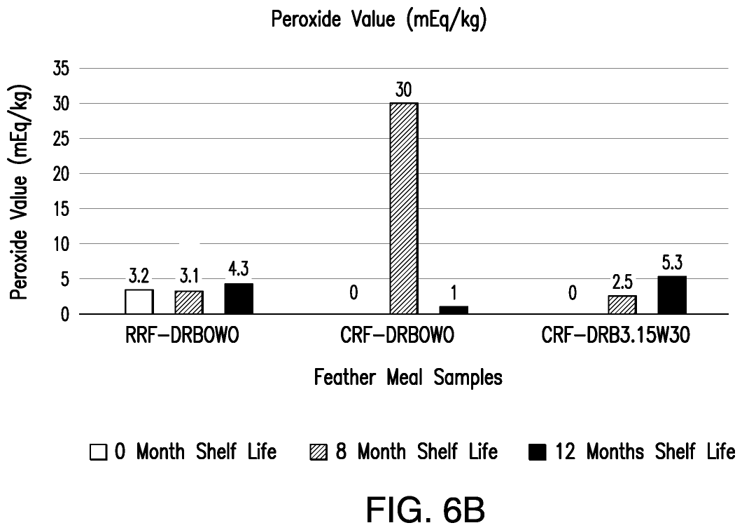

Results are shown in FIGS. 6A and 6B. For the RRF sample, it was observed that hexanal values were stable around 12-15 and peroxide values were stable between 3.2-4.3. For the CRF sample, it was observed that hexanal levels continued to increase, while peroxide values were extremely high at 8 months, then none at 12 months. Finally, for the DRB sample, it was observed that hexanal values were stable at 5 for 12 months, and peroxide values increased from 0 to 5.3.

The addition of the defatted rice bran kept the hexanal and PV values very low for 12 months, and both values were observed to be within the global limits. In contrast, the CRF sample did not have stability starting from time zero. The RRF sample had good hexanal and PV stability, but both levels were above the established limits for poultry meal.

### Example 5. Presence of Volatile Compounds Related to Pleasant Aroma

A headspace analysis was performed to determine the volatile compounds present in each sample of feather meal (RRF, CRF, and DRB, as discussed above). The Intertek gas chromatography-mass spectrometry (GC-MS) method was used with an internal standard in order to compare data from one sample to another. Volatile compounds were classified according to their description in the literature (green for pleasant, yellow for neutral, red for unpleasant). The aroma descriptor reference used was from The Good Scents Company and PubChem. Results are shown in Tables 5 and 6 below.

TABLE 5
Volatile compounds detected in feather meals

| Aroma Description | | | | | | | |
|---|---|---|---|---|---|---|---|
| (Lit) | | RRF_082418 | Ratio | CRF_09418 | Ratio | DRB_09718 | Ratio |
| PLEASANT | Waxy, soapy floral | | | Undecanal | 0.0045 | | |
| | aldehydic citrus green | | | | | | |
| | fatty cloth laundered | | | | | | |
| | cloth | | | | | | |
| | Sweet aldehydic, | | | Decanal | 0.0072 | | |
| | waxy, orange peel, | | | | | | |
| | citrus floral | | | | | | |
| | Fruity fungal meaty | | | 2-hexanone | 0.0136 | | |
| | buttery | | | | | | |
| | Green, minty, herbal, | | | Octane | 0.0207 | | |
| | rosemary, cooling | | | | | | |
| | Nutty cocoa roasted | | | | | Methyl | 0.0054 |
| | chocolate peanut green | | | | | pyrazine | |
| | Alcoholic, fermented, | 1-propanol | 0.0053 | 1-propanol | 0.0097 | | |
| | fusel, tequlia, musty, | | | | | | |
| | yeasty, sweet, fruity, | | | | | | |
| | apple, pear | | | | | | |
| | Citrus Orange Fresh | Limonene | 0.0182 | | | Limonene | 0.0143 |
| | Sweet | | | | | | |
| | Acetone ethereal | 2-butanone | 0.0297 | 2-butanone | 0.0443 | 2-butanone | 0.022 |
| | fruity camphoreous | | | | | | |
| | Musty cocoa coffee | 2-methyl | 0.1156 | 2-methyl | 0.0347 | 2-methyl | 0.0533 |
| | nutty | butanal | | butanal | | butanal | |
| | Fresh aldehydic (sweet) | 2-methyl | 0.1223 | 2-methyl | 0.048 | 2-methyl | 0.0673 |
| | floral pungent | propanal | | propanal | | propanal | |
| | Fruity green earthy | 2-pentylfuran | 0.0526 | 2-pentylfuran | 0.1746 | 2-pentylfuran | 0.0246 |
| | beany vegetable | | | | | | |
| | Ethereal aldehydic | 3-methyl | 0.2895 | 3-methyl | 0.0772 | 3-methyl | 0.2171 |
| | chocolate peach fatty | butanal | | butanal | | butanal | |
| | Pungent, etherial, | Acetaldehyde | 0.2058 | Acetaldehyde | 0.2453 | Acetaldehyde | 0.1886 |
| | fresh, lifting, | | | | | | |
| | penetrating, fruity | | | | | | |
| | and musty | | | | | | |
| | Green fatty leafy | Hexanal | 0.2547 | Hexanal | 0.8842 | Hexanal | 0.112 |
| | vegetable fruity | | | | | | |
| | clean woody | | | | | | |
| | Waxy aldehydic citrus | Nonanal | 0.0222 | Nonanal | 0.0592 | Nonanal | 0.0123 |
| | fresh green lemon peel | | | | | | |
| | cucumber fatty | | | | | | |
| | Aldehydic waxy citrus | Octanal | 0.0114 | Octanal | 0.0349 | Octanal | 0.0062 |
| | orange peel green fatty | | | | | | |
| | Fermented bready | Pentanal | 0.1207 | Pentanal | 0.3102 | Pentanal | 0.0536 |
| | fruity nutty berry | | | | | | |
| NEUTRAL | Alcoholic musty woody | | | Isopropanol | 0.0213 | | |
| | Ethereal apple pear | Acetone | 0.1012 | Acetone | 0.1563 | Acetone | 0.1034 |
| | Pungent cocoa musty | Butanal | 0.0383 | Butanal | 0.0714 | Butanal | 0.0131 |
| | green malty, acrid | | | | | | |
| | Unpleasant, ethereal | Propanal | 0.0123 | Propanal | 0.0226 | Propanal | 0.0051 |
| | pungent earthy | | | | | | |
| | alcoholic winey cognac | | | | | | |
| | whiskey brandy cocoa | | | | | | |
| | nutty meaty grape | | | | | | |
| UNPLEASANT | Sharp acetic cheesy | Butanoic | 0.0348 | | | | |
| | buttery fruity | Acid | | | | | |
| | Alcoholic, ethereal, | Ethanol | 0.0086 | | | | |
| | medicinal | | | | | | |
| | Pungent acidic cheesy | Propanoic | 0.0651 | | | | |
| | vinegar | acid | | | | | |
| | Sharp pungent sour | Acetic Acid | 0.086 | | | | |
| | vinegar | | | | | | |
| | Chemical | | | Hexane | 0.007 | | |
| | Rotten Cabbage or eggs | | | Methanethiol | 0.028 | Methanethiol | 0.0224 |
| | Ammonia-like to | N-N-dimethyl | 0.3211 | N-N-dimethyl | 0.0364 | N-N-dimethyl | 0.0369 |
| | fishlike | methylamine | | methylamine | | methylamine | |
| | Petroleum | 2-methyl-1-1- | 0.0078 | 2-methyl-1-1- | 0.0159 | 2-methyl-1-1- | 0.0099 |
| | | propene | | propene | | propene | |
| | pungent fermented | 1-pentanol | 0.0446 | 1-pentanol | 0.1705 | 1-pentanol | 0.021 |
| | Petroleum-like odor | Pentane | 0.0188 | Pentane | 0.0426 | Pentane | 0.0162 |

TABLE 6
Volatile Compounds Unique to Each Feather Meal

| Compounds found | Compounds found | Compounds found |
|---|---|---|
| only in RRF | only in CRF | only in DRB |
| Butanoic Acid | Isopropanol | Methylpyrazine |
| Ethanol | Undecanal | |
| Propanoic acid | Decanal | |
| Acetic Acid | 2-hexanone | |
| | Octane | |
| | Hexane | |

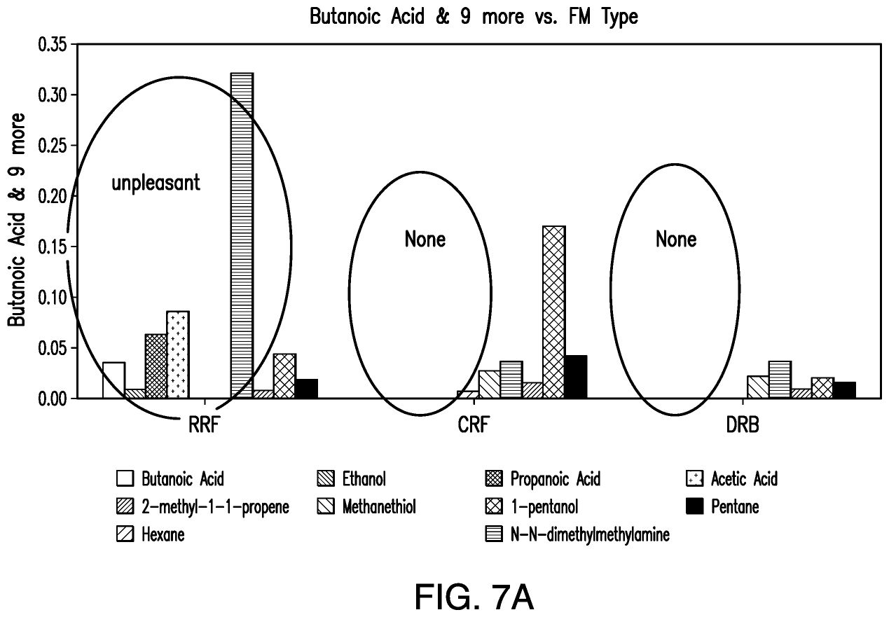

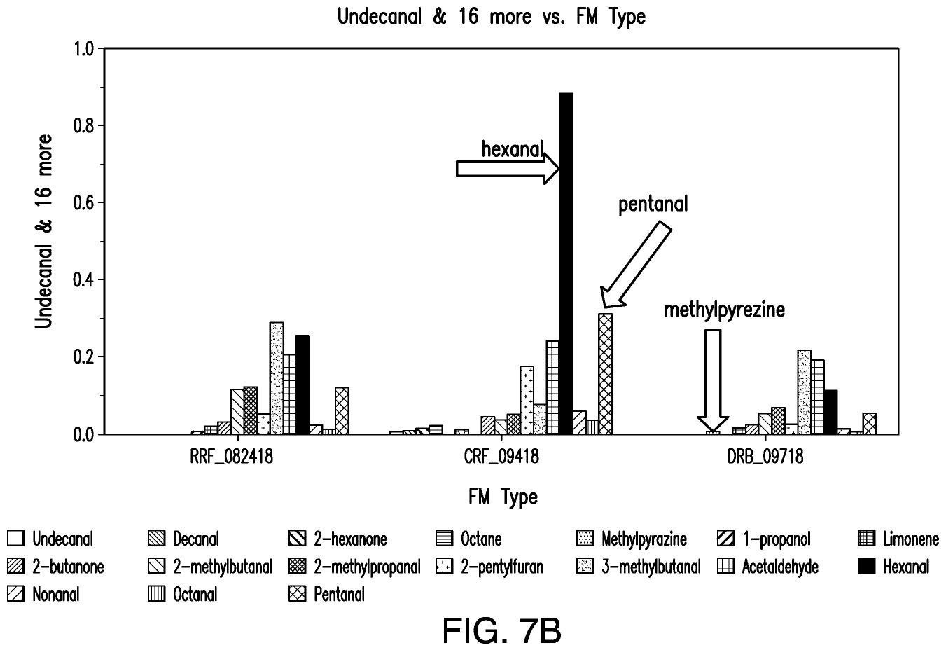

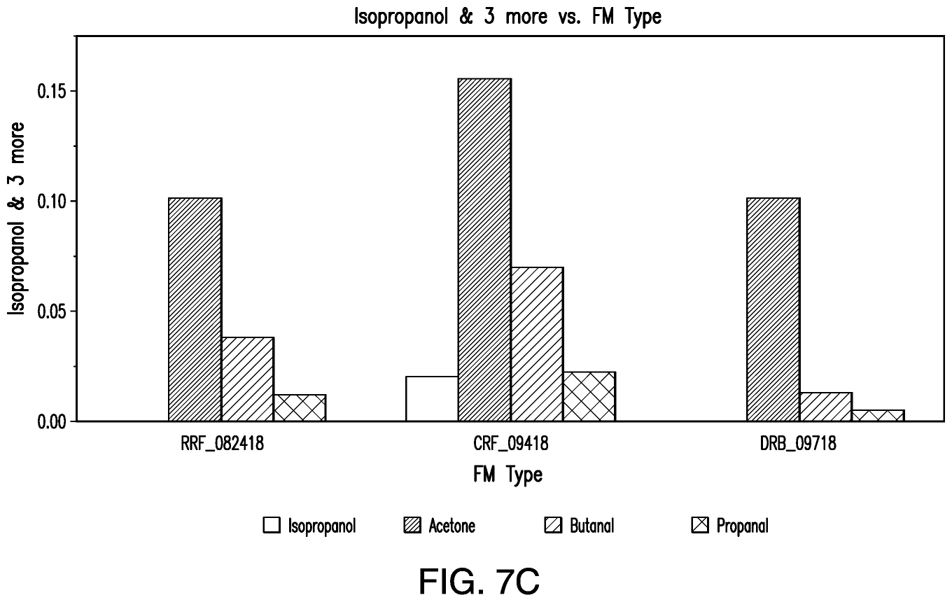

It was observed that the CRF and DRB samples did not include butanoic acid, ethanol, propanoic acid, or acetic acid. Furthermore, the RRF sample included very high levels of N,N-dimethylmethylamine, which is described as having an ammonia or fish-like aroma. It is possible that these compounds are related to the putrid, sour, barnyard aroma of RRF feather meal. Levels of unpleasant and pleasant volatile compounds in each of the feather meal samples are shown in FIGS. 7A and 7B, respectively. Levels of neutral volatile compounds are shown in FIG. 7C. Bar heights represent relative concentration.

Each type of feather meal was observed to have at least one compound that was unique to that type of feather meal. The RRF sample had compounds that are likely related to strong unpleasant odors, which the other two feather meal samples did not have. Furthermore, methylpyrazine, which is a product of a Maillard reaction, was only observed in the DRB sample.

### Example 6. Freshness and Cleanness of Raw Feathers Linked to Aroma

Different methods of collecting and cleaning raw feathers were tested in order determine which parameters resulted in the feather meal having the least undesired aroma notes, such as putrid, barnyard, and sour aroma notes.

Raw feathers were collected upon arrival at a rendering plant about a two hour driving distance away from the packing facility. The feathers were subject to four different test methods of washing:

Tote 1 (T1) RF: raw feathers were washed a total of three times: twice at the rendering plant, and once upon arrival at the packing facility prior to packing. Ice cubes were placed on top during transportation.

Tote 2 (T2) RF: raw feathers were washed a total of two times at the rendering plant. Ice cubes were placed on top during transportation.

Tote 3 (T3) RF: raw feathers were washed a total of one time at the rendering plant. Ice cubes were placed on top during transportation.

Tote 4 (T4) RF: raw feathers were not washed and ice cubes were not placed on top during transportation.

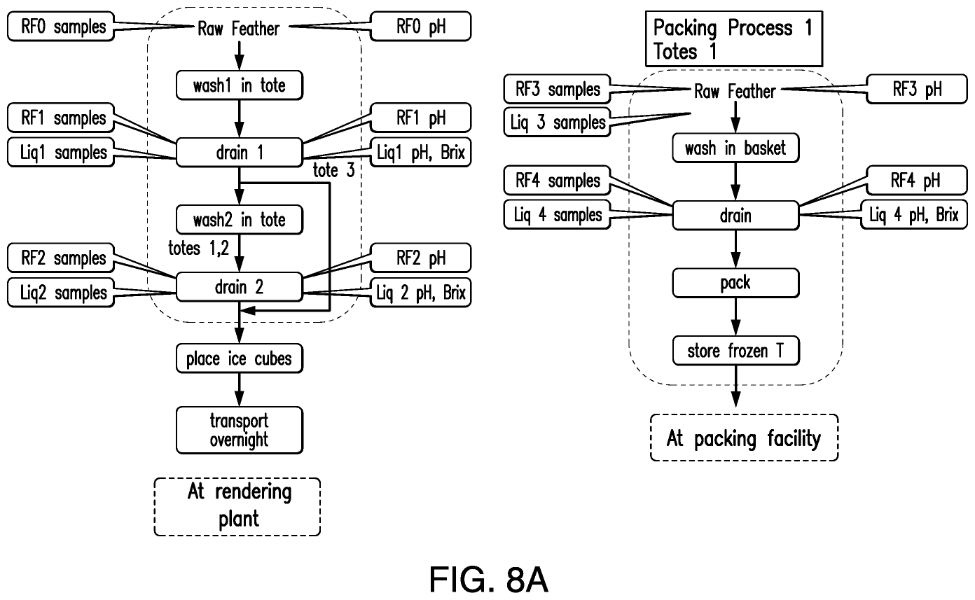

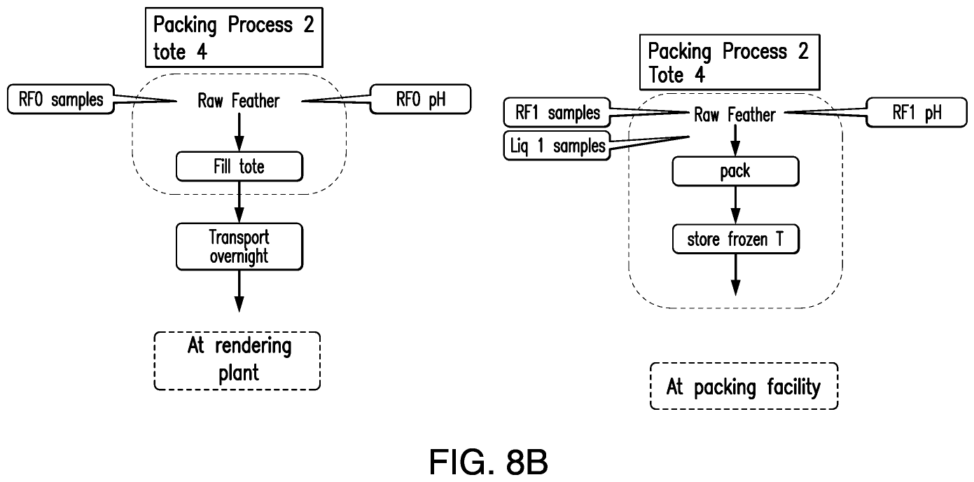

The feathers were washed with hot water (180° F.) and then tap water with no addition of any chemicals. Ice cubes were used on top of the tote carrying the feathers during transportation, except for the control group of unwashed raw feathers meant to simulate regular raw feather typically used in conventional feather meal production processes. Feather meal was produced from the four different samples of feathers. Schematic diagrams showing the test methods of washing are shown in FIGS. 8A and 8B.

The study was carried out over fifteen days total. At Day 1, the feathers were collected at the rendering plant; T1 was washed twice, T2 was washed twice, and T3 was washed once. At Day 2, the feathers arrived at the packing facility and T1 was washed one more time. Day 3 was the first day of the ambient study and Day 15 was the last day of the ambient study.

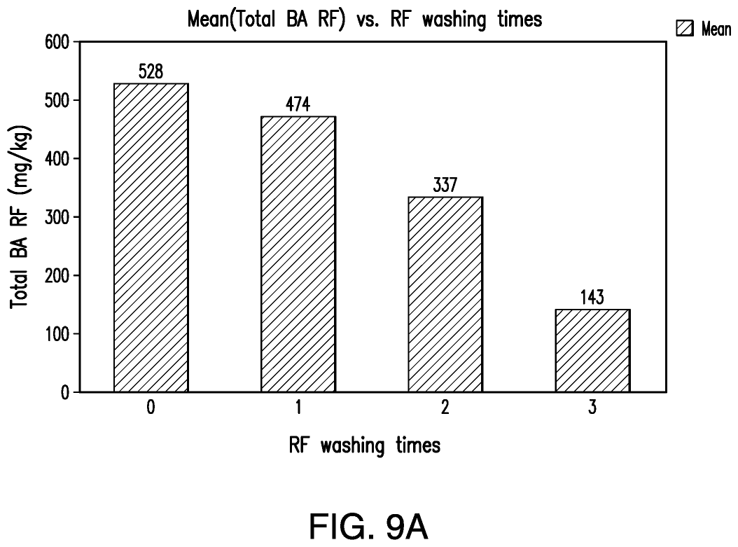

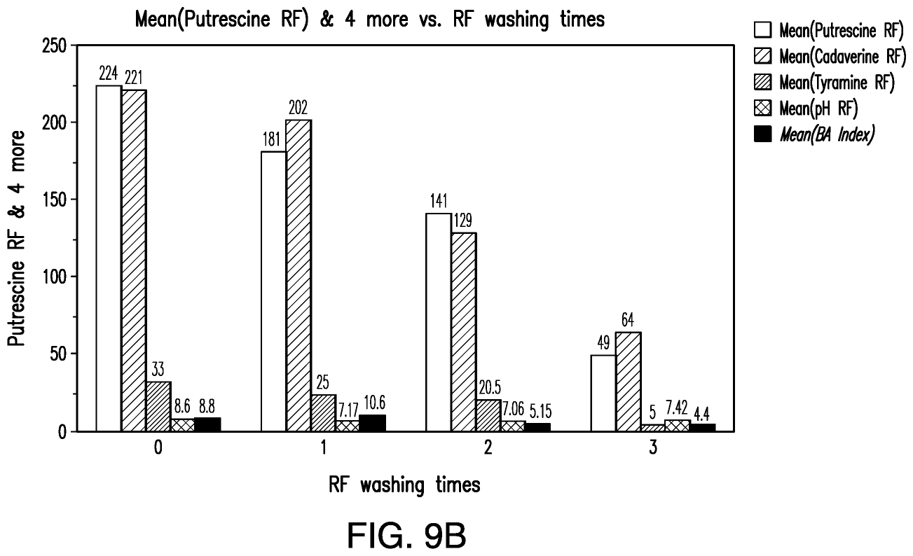

FIG. 9A shows an overall decrease in total biogenic amines (TBA) correlating to an increase in the number of washes. The total biogenic amine content was calculated as the sum of putrescine, cadaverine, tyramine, spermidine, and spermin (mg/kg). The total biogenic amine content was reduced from 528 mg/kg (T4, no washing) to 143 mg/kg (T1, washed three times). Similarly, FIG. 9B shows an overall decrease in each individual amount of biogenic amine following washing. Furthermore, the unwashed raw feathers and raw feathers washed once showed the highest biogenic amine index (BAI) at 8.8 and 10.6, respectively, while washing the raw feathers twice or three times reduced the BAI by about half.

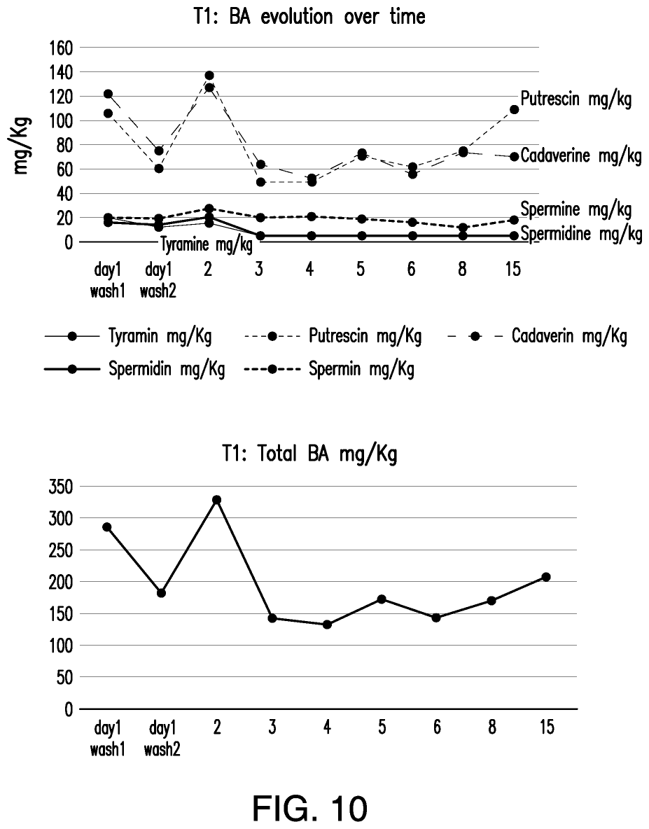

FIG. 10 shows levels of each compound over time in sample T1. It was observed that putrescine and cadaverine levels were reduced with each washing of the raw feathers and remained constant throughout the study until Day 15. It appeared that the total biogenic amine count is driven by the amount of putrescine and cadaverine.

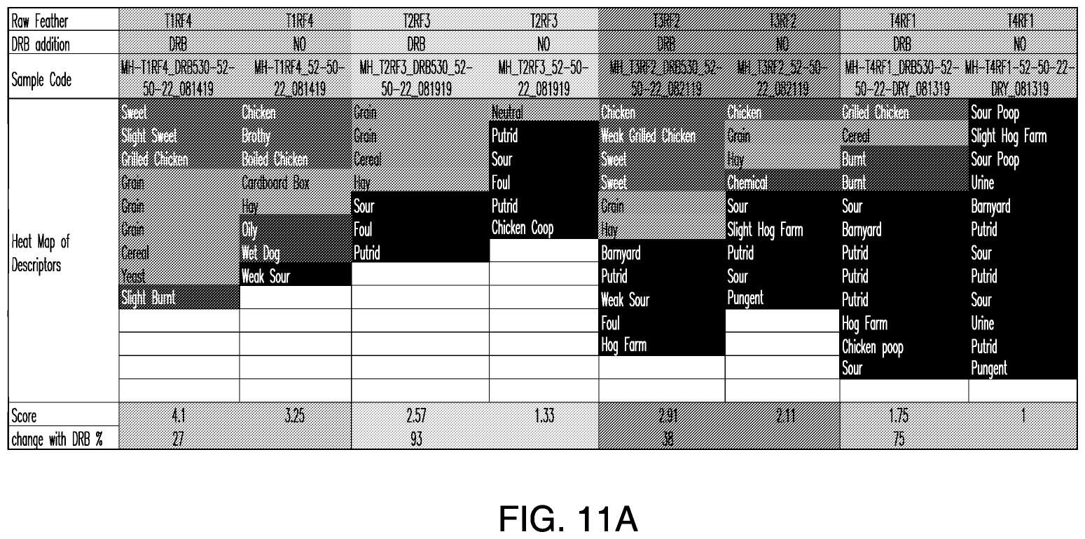

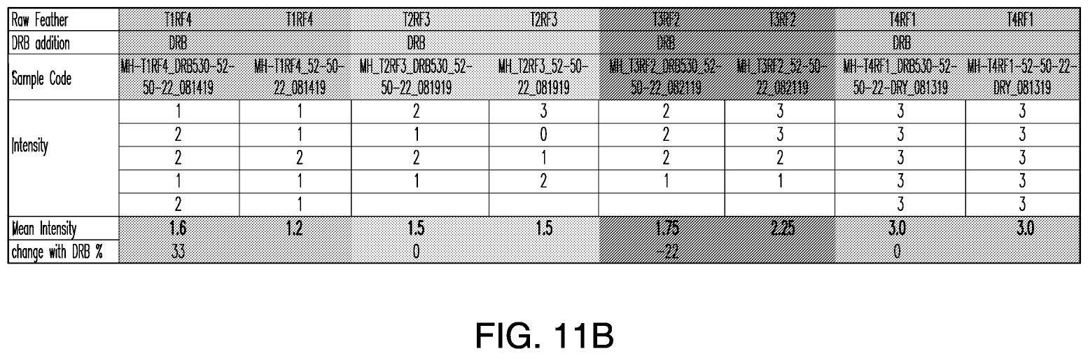

The feathers were then used to produced feather meal, either with or without the presence of defatted rice bran. Results are shown in FIG. 11A. It was observed that feather meal produced from the T1RF4 sample, which was the cleanest, had the highest aroma score both with and without defatted rice bran. Furthermore, the feather meal produced from the T4RF1 sample, which was not washed, had the worst aroma score both with and without defatted rice bran. Notably, T2RF3 (washed twice) was worse than T3RF2 (washed once). A possible explanation for this could be that T3RF2 was collected on top of the tote, while the entire tote was collected for T2RF3. Furthermore, addition of the defatted rice bran led to an increased aroma score from 27% (T1RF4) to 93% (T2RF3) and more desirable aroma notes were observed.

As shown in FIG. 11B, it was observed that cleaning the raw feathers did not appear to have a clear impact on the aroma intensity. Feather meal from the clean raw feather had the lowest intensity, and feather meal from the regular raw feathers without washing had the highest intensity. Addition of defatted rice bran increased aroma intensity only in feather meal from the cleanest raw feather. Addition of defatted rice bran had no effect on feathers washed none or two times, and led to a decreased aroma intensity in feather meal from raw feathers washed once.

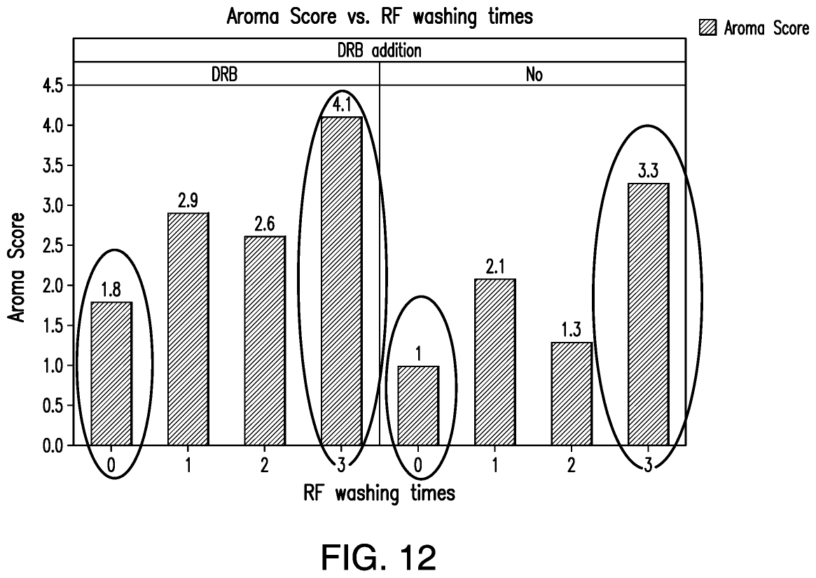

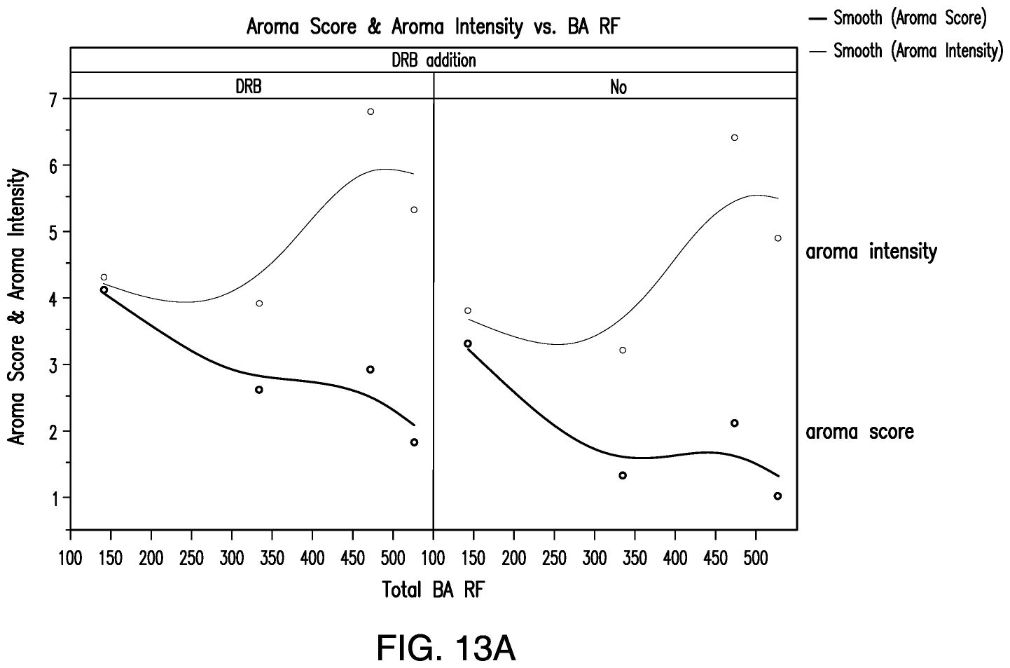

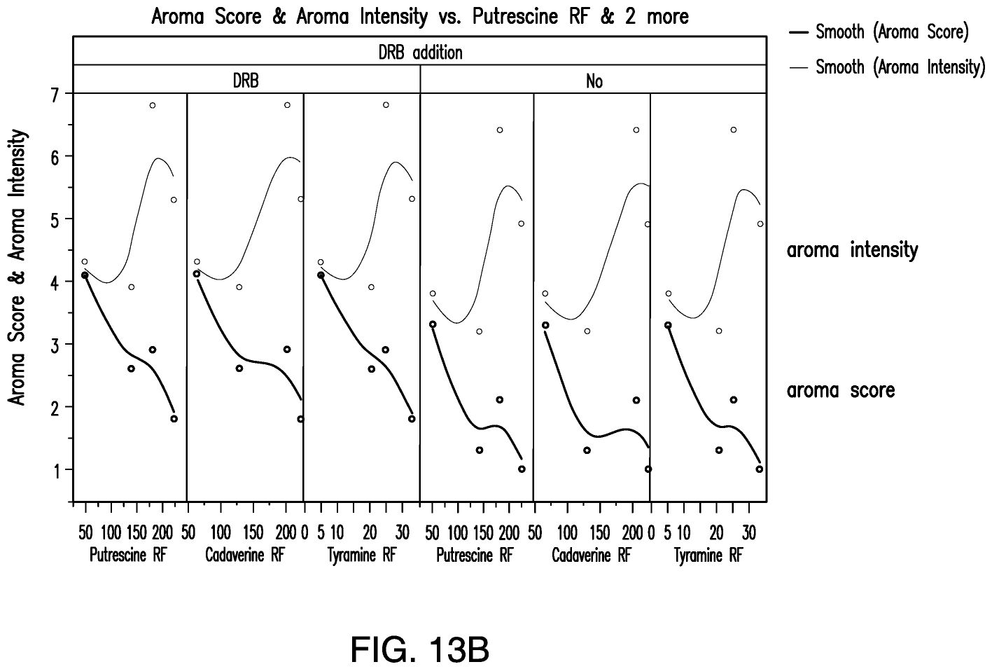

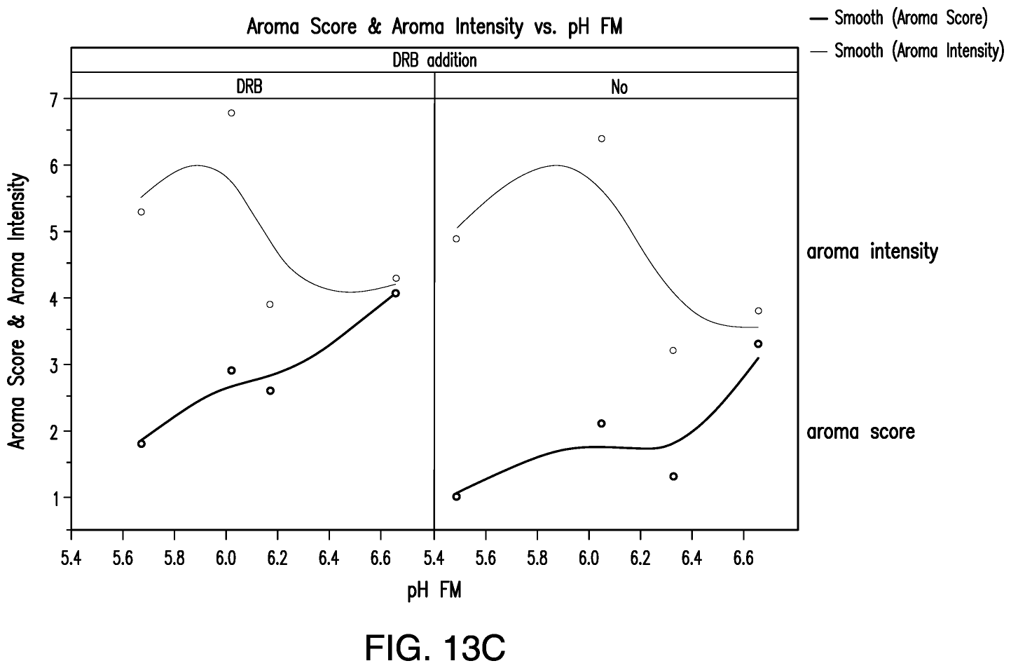

Aroma score versus number of washes is plotted in FIG. 12. As discussed above, aroma score increased with number of washings, but there is an inconsistency between one and two washings. Both feather meals (with and without the addition of defatted rice bran) showed the same pattern for aroma score and intensity. Aroma score plotted against total biogenic amine concentration is shown in FIG. 13A. The relationship between the aroma score and total biogenic amine concentration is nearly identical between feather meal with and without defatted rice bran. Aroma score decreased as total biogenic amine count increased. Similarly, aroma score plotted against putrescine, cadaverine, and tyramine concentration is plotted in FIG. 13B. It was observed that aroma score decreased as concentrations of the three compounds increased, while aroma intensity increased as concentration of the three compounds increased. Finally, FIG. 13C shows aroma score and intensity versus feather meal pH. Aroma score increased as pH of feather meal increased for feather meal made with and without defatted rice bran. The aroma intensity was higher up to a pH of 6.1, then decreased at pH levels above this value.

### Example 7. Effect of Washing on pH of Raw Feathers Over Time

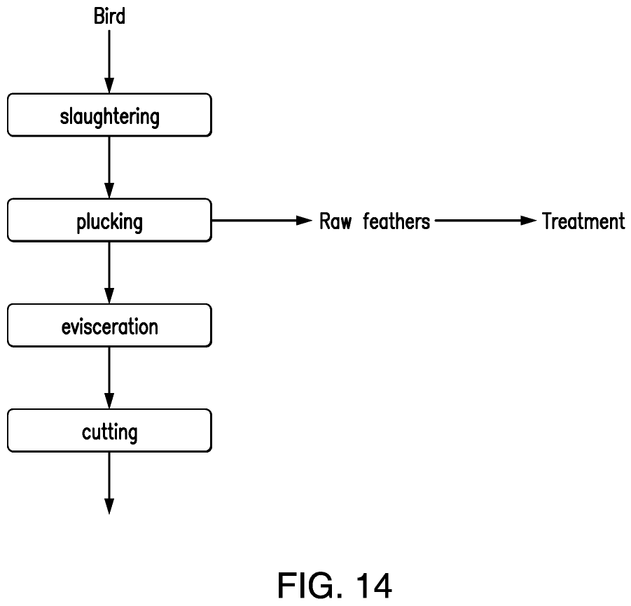

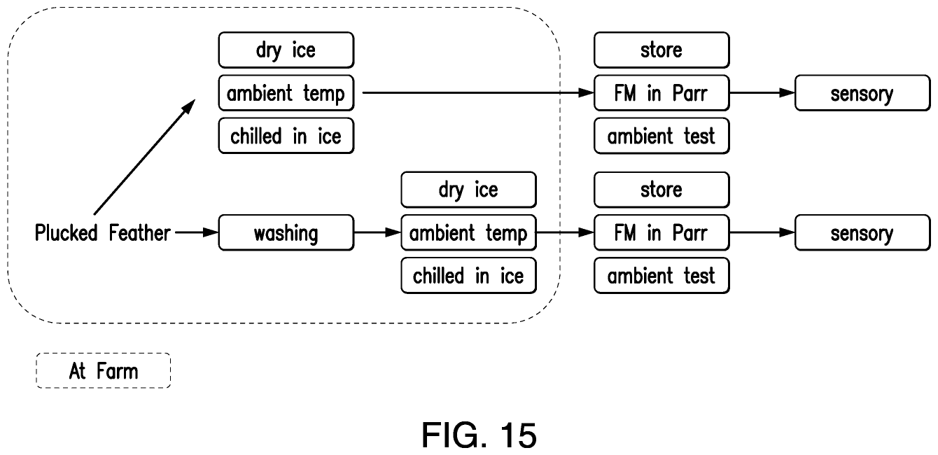

The effect of freshness of the raw feathers on pH was measured. Raw feathers were collected at a firm during chicken slaughtering following plucking, which is the freshest source for collecting raw feathers. The collected raw feathers were subject to two treatments. Treatment 1: No washing (taken from plucking operation). Treatment 2: Washed twice—first washing used hot water, second washing used ambient tap water. A schematic diagram of the test methods is shown in FIG. 14. One portion of the raw feathers was stored at ambient temperature, while the second part was stored in cold temperature (i.e., with ice cubes). The pH of the feathers was measured every two hours on the first day, then once a day for a total of six days. Some of the feathers were frozen in dry ice in order to maintain original conditions upon collection, particularly to maintain the presence of biogenic amines. The raw feather treatment plan is shown in FIG. 15.

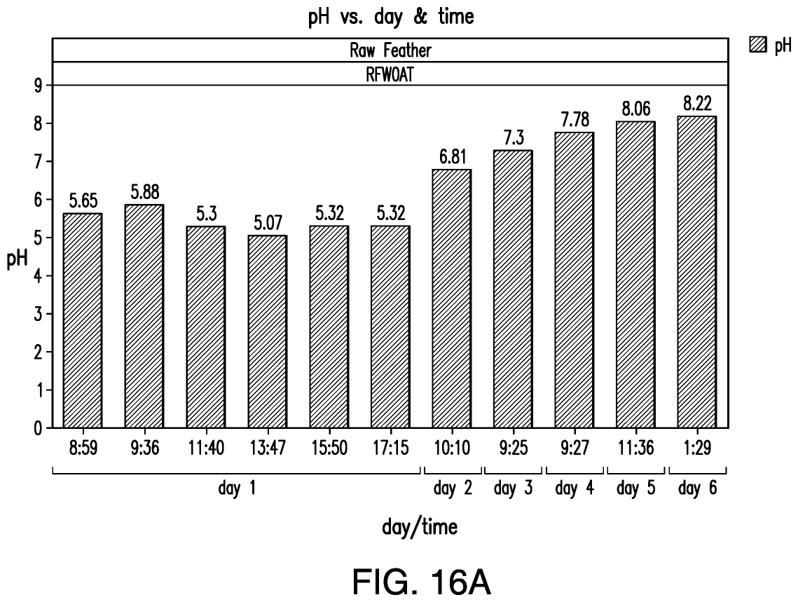

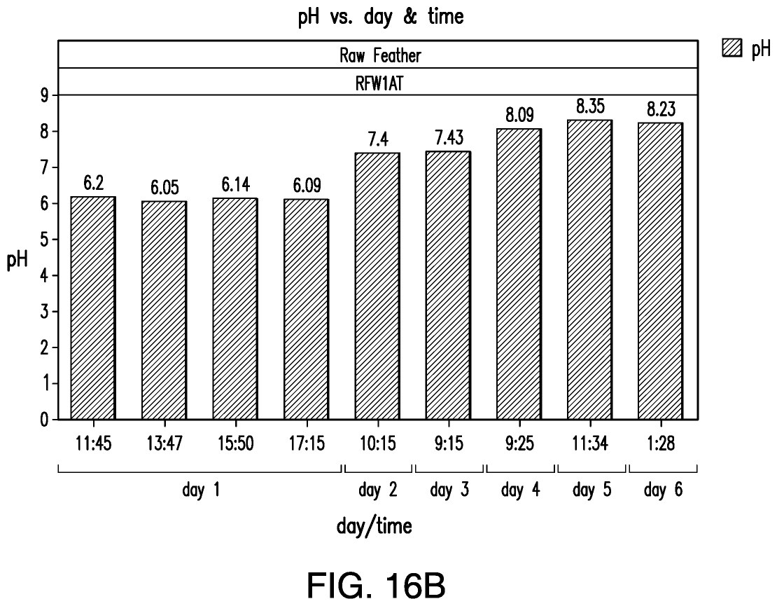

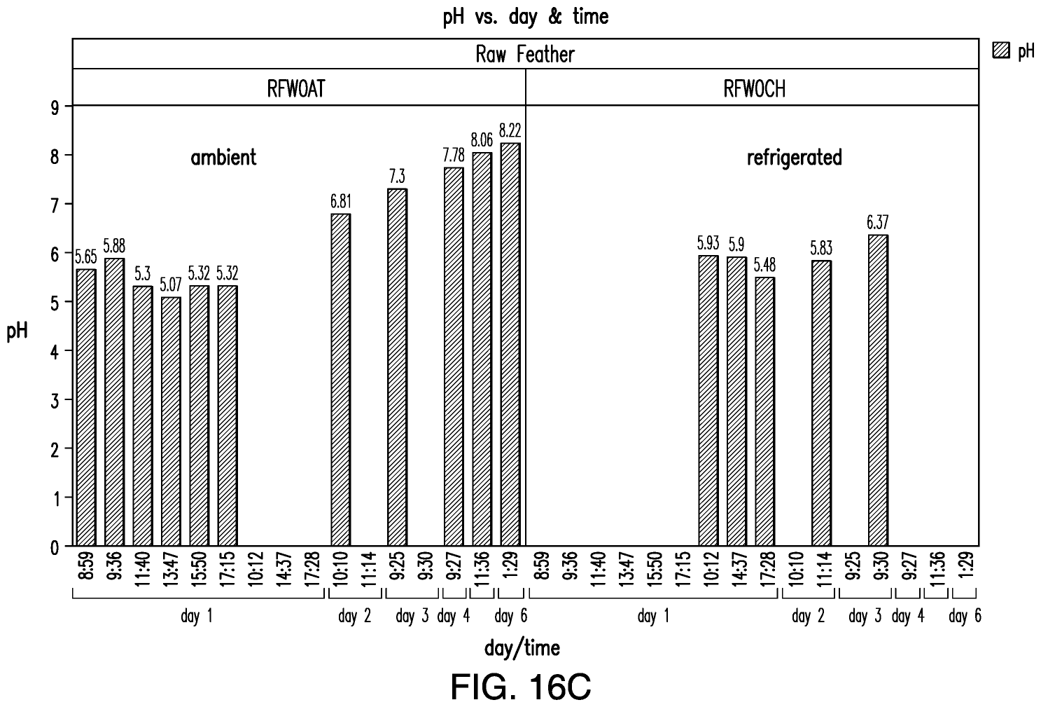

The pH of unwashed raw feathers (Treatment 1) stored at ambient temperature is provided in FIG. 16A. The pH was 5.65 at the beginning of Day 1 and decreased to 5.32 by the end of the day. On Day 2, the pH increased to 6.81 and kept increasing until reaching 8.22 on Day 6. In contrast, the pH of washed raw feathers (Treatment 2) stored at ambient temperature is provided in FIG. 16B. At the beginning of the first day, the pH was 6.2 and remained relatively constant on Day 1. This pH was higher than the raw feathers that had not been washed. On Day 2, the pH was observed to be 7.4 and remained at this level on Day 3. On Day 4, the pH increased to 8.09, where it remained for another two days.

The comparison of the pH of unwashed raw feathers over six days stored at both ambient and refrigerated temperatures is shown in FIG. 16C. As shown in the figure, the pH changed more slowly over time for the refrigerated sample.

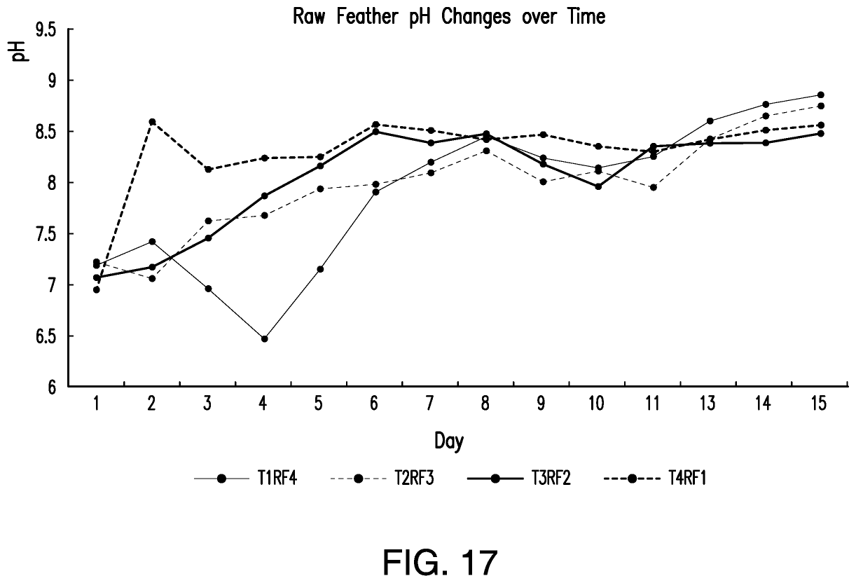

FIG. 17 shows the change in pH for the raw feather samples described in Example 6. For the T1RF4 sample (washed three times), the pH dropped until Day 4, then increased until Day 8. For the T2RF3 sample (washed twice), the pH increased until Day 8. For the T3RF2 sample (washed once), the pH increased until Day 6 and then remained relatively constant until Day 8. For the T4RF1 sample (not washed), the pH increased rapidly on Day 2 and remained relatively constant until Day 15. Overall, it was observed that the T1 and T4 samples had unique patterns until Day 8, while T2 and T3 have similar patterns until Day 8. All four samples showed similar patterns of pH change following Day 8.

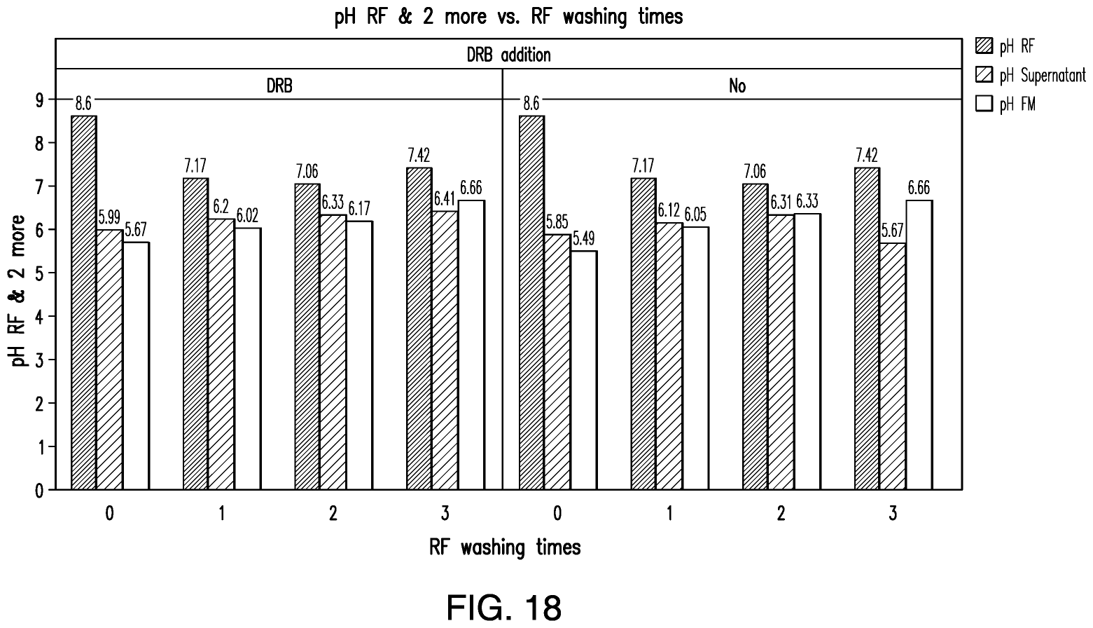

The pH of raw feathers, supernatant, and feather meal made therefrom plotted against the number of washes is shown in FIG. 18. It was observed that the pH of the raw feather was the highest and decreased as processing into feather meal progressed, except for the raw feather that was washed three times. The pH of the feather meal increased as the number of washings of the raw feathers increased, while pH of the raw feathers themselves decreased as the number of washings increased. The same pattern is observed for feather meal made with and without defatted rice bran.

### Example 8. Processing Conditions and Aroma of Resultant Feather Meal

Processing conditions for developing feather meal from raw feathers were varied to determine the effect of said conditions on the aroma profile of the resultant feather meal. Feather meal was produced from raw feathers in the presence of defatted rice bran. The processing equipment used was DVT-22 (mini hydrolyzer), a small Z blade mixer used as a dryer, and Urschel Comitrol 1700 used for coarse cutting head and microcut head. The raw materials used were regular raw feather (RRF), clean raw feather (CRF), and clean raw feather in the presence of defatted rice bran (DRB). Sensory assessment was performed by bench top assessment by PALS team following established standards of aroma descriptors.

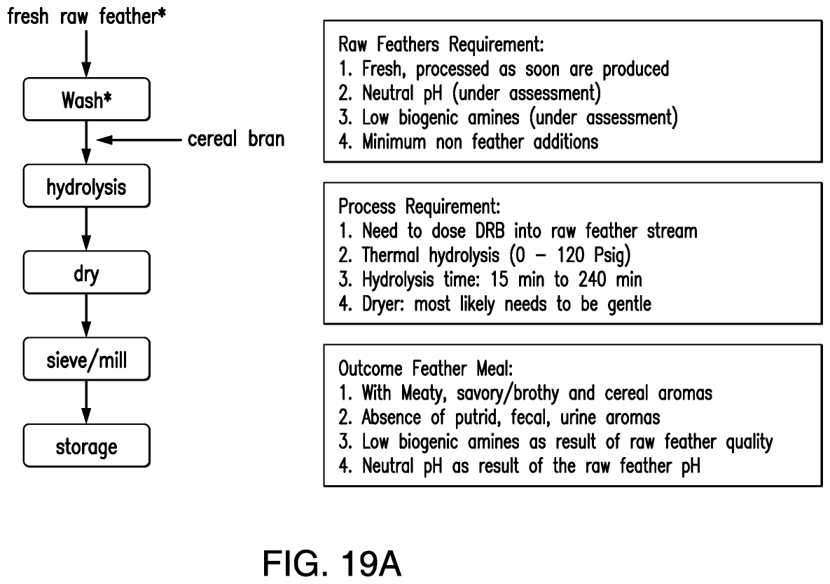

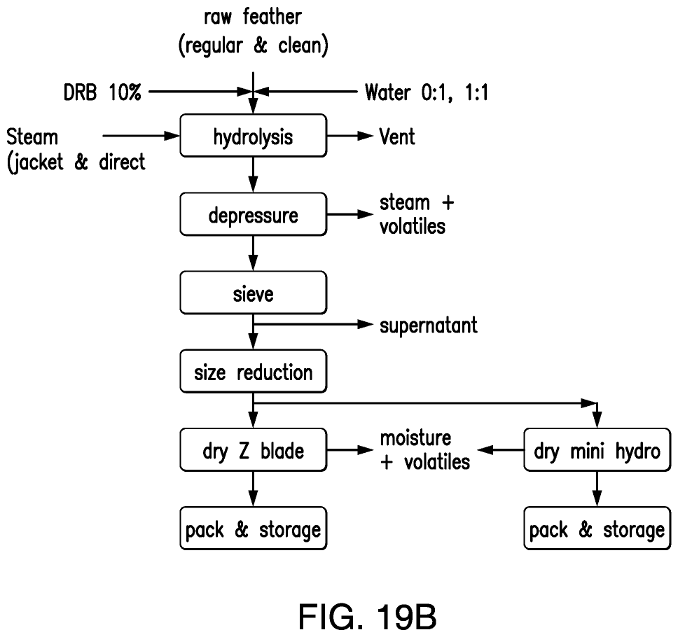

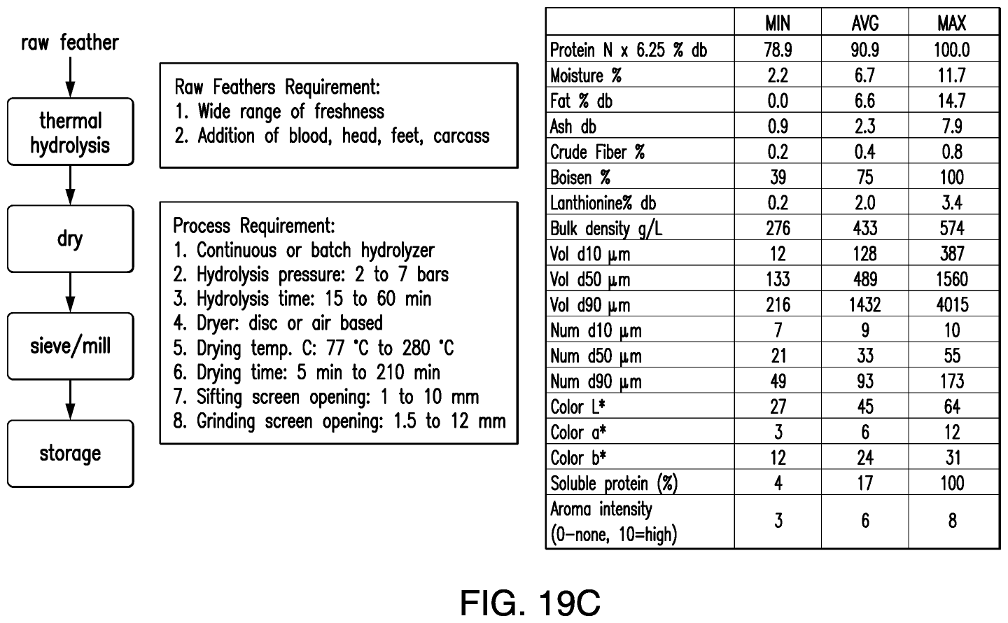

A general schematic diagram of processing methods is provided in FIG. 19A. The tested methods are shown in the schematic diagram of FIG. 19B. In comparison, FIG. 19C shows the conventional process for producing feather meal and the analytical data of the resultant feather meal.

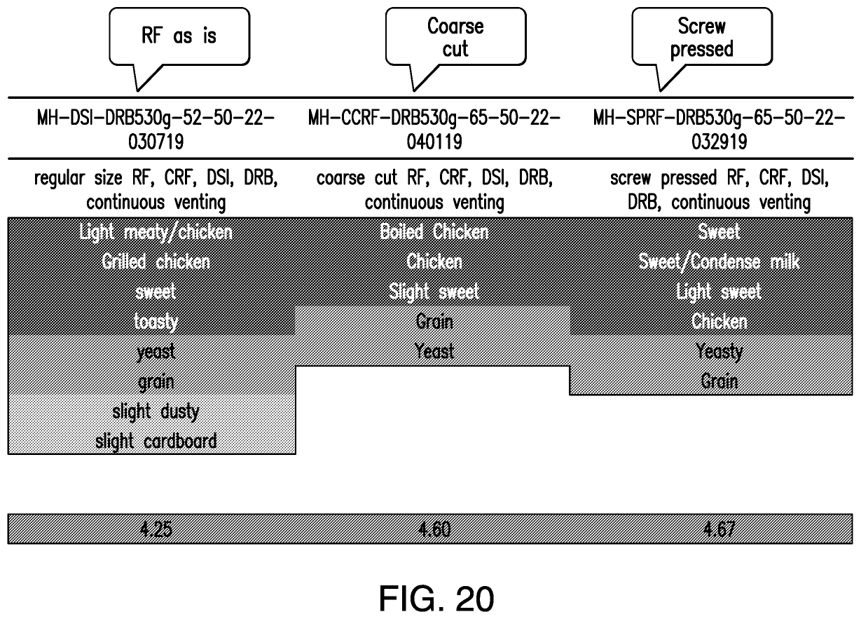

In one experiment, the effect of size reduction of the raw feathers starting material on the resultant feather meal aroma was determined. Cleaned raw feathers were tested as is, coarse cut, and screw pressed. Hydrolysis was performed in the presence of defatted rice bran and under direct steam. Drying was performed with a small Z blade mixer. Sensory assessment was performed bench top assessment by PALS team. Results are shown in FIG. 20. It was observed that feather meal made from coarse cut and screw pressed raw feathers had a slightly better aroma score compared to feather meal made from feathers of regular size. The regular size feather meal had dusty and cardboard notes. Raw feathers of smaller size produced slightly better aroma descriptors.

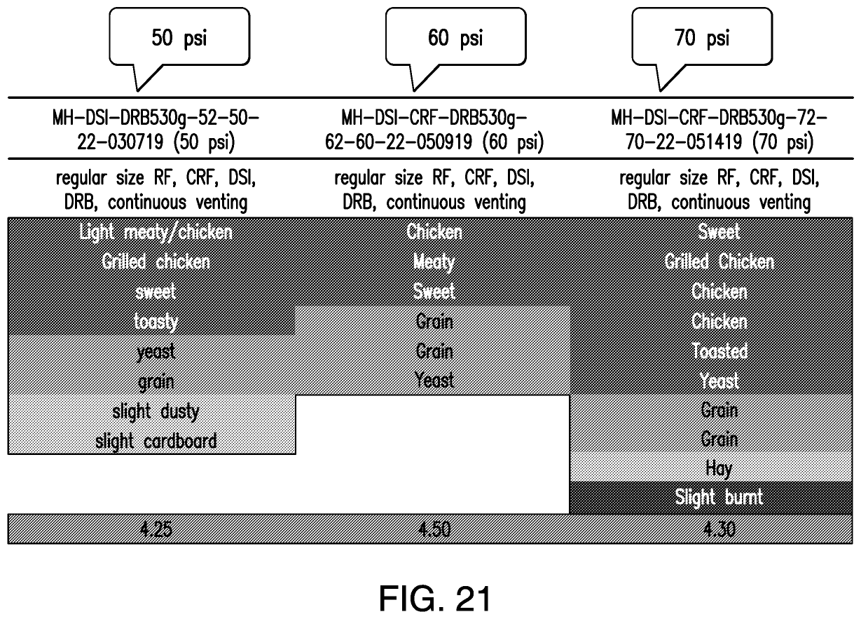

In another experiment, the effect of hydrolysis pressure on aroma score was tested. Hydrolysis was performed at 50 psi, 60 psi, and 70 psi. Hydrolysis time was kept at 22 minutes for each test. Cleaned raw feathers were used in the presence of 10% by weight of defatted rice bran. Results are shown in FIG. 21. It was observed that the aroma score of feather meal processed at 60 psi had a slightly higher aroma score due to absence of a neutral aroma descriptor. The aroma scores of the feather meals processed at 50 psi and 70 psi were observed to be similar. Hydrolysis pressure appeared to have an effect on the aroma score.

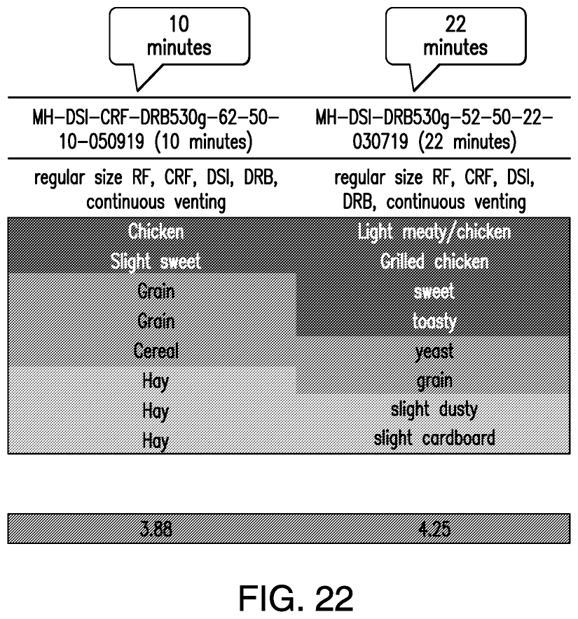

The following experiment determined the effect of hydrolysis time on the aroma score of feather meal. The hydrolysis times tested were 10 minutes and 22 minutes. Hydrolysis pressure was kept at 50 psi for each of the tests. Cleaned raw feathers were used and in the presence of defatted rice bran. Results are shown in FIG. 22. It was observed that feather meal processed for 22 minutes had a higher aroma score and had more a developed aroma that included, e.g., chicken and sweet aromas. On the other hand, feather meal processed for 10 minutes had more neutral aromas, such as hay. It appeared that hydrolysis times can affect aroma score, and in this experiment, performing hydrolysis for 22 minutes led to a better aroma profile.

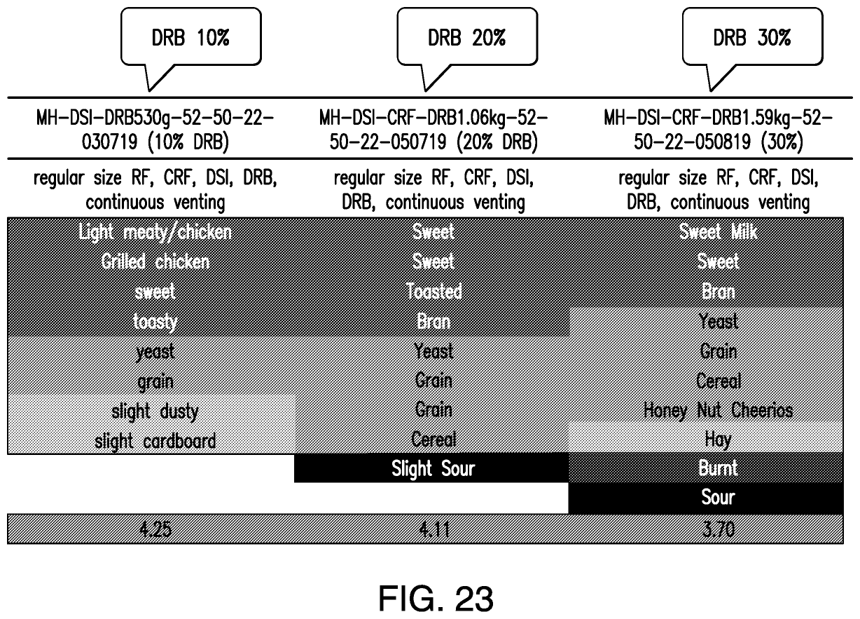

Another experiment was performed to determine the effect of different amounts of defatted rice bran on the overall aroma score of feather meal. The levels of defatted rice bran tested were 10% by weight, 20% by weight, and 30% by weight. Defatted rice bran at 10% was the most commonly used amount of defatted rice bran in the previous experiments. Hydrolysis was performed at 50 psi and for a duration of 22 minutes. Cleaned raw feathers were used in this experiment. Results are shown in FIG. 23. It was observed that the aroma score of feather meal with 10% defatted rice bran was slightly higher than that with 20% defatted rice bran. Furthermore, it was observed that 10% defatted rice bran led to a much higher aroma score compared to 30% defatted rice bran. The feather meals with 20% and 30% defatted rice bran were observed to have relatively unpleasant sour notes in the aroma. The 20% and 30% defatted rice bran feather meals also lacked chicken notes, and instead had more sweet and grain notes. It was determined that a defatted rice bran level of about 10% can lead to a more chicken-like and less unpleasant aroma compared to higher amounts of defatted rice bran when producing feather meal.

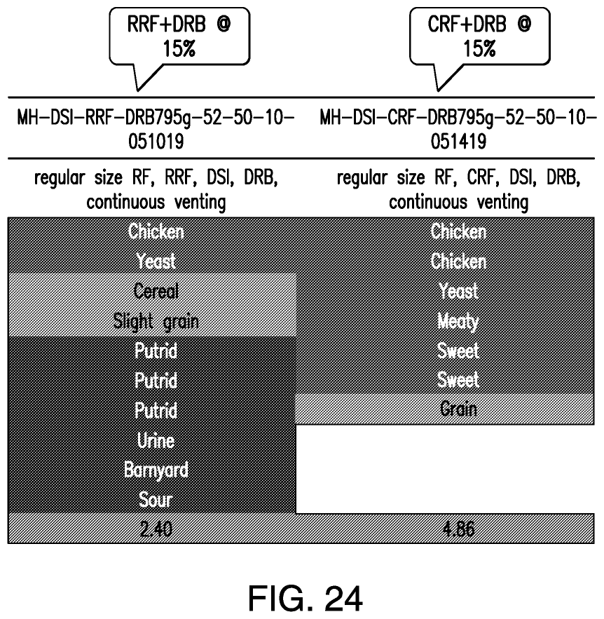

Finally, the last experiment performed determined the effect of including defatted rice bran on aroma score of feather meal produced from regular raw feather compared to cleaned raw feather. Regular raw feather and cleaned raw feather were tested with 15% defatted rice bran in each sample. Hydrolysis was performed at 50 psi and for 10 minutes. Results are shown in FIG. 24. Feather meal made from cleaned raw feather in the presence of defatted rice bran had a much higher aroma score, and chicken, meaty, and sweet notes were observed. On the other hand, feather meal made from regular raw feathers in the presence of defatted rice bran still had putrid, barnyard, and sour notes and a consequently low aroma score. In conclusion, the freshness and cleanness of the raw feathers still plays a critical role in the production of feather meal lacking an undesirable or unpleasant aroma profile. Even in the presence of rice bran, regular raw feathers led to an unpleasant aroma and low aroma score.

Overall, it was observed that there are subtle positive differences in the resultant aroma profile when raw feathers were size reduced, processed at 22 minutes compared to 10 minutes, hydrolyzed at 60 psi compared to 50 psi and 70 psi, and in the presence of 10% defatted rice bran compared to 20% and 30%.

It is to be understood that while certain forms of the method for producing food product ingredient from keratinous protein-containing materials have been illustrated and described herein, it is not to be limited to the specific forms or arrangement of parts described and shown. Modifications to embodiments described in this document, and other embodiments, will be evident to those of ordinary skill in the art after a study of the information provided in this document. The information provided in this document, and particularly the specific details of the described exemplary embodiments, is provided primarily for clearness of understanding and no unnecessary limitations are to be understood therefrom. In case of conflict, the specification of this document, including definitions, will control.

Patents, patent applications, publications, product descriptions, and protocols may be cited throughout, the disclosures of which are incorporated herein by reference in their entireties for all purposes.

1. A process for producing a food product ingredient formed from a keratinous protein-containing material, the process comprising:
cleaning the keratinous protein-containing material with a cleaning solution,
combining the keratinous protein-containing material and a cereal bran to form a mixture, and
subjecting the mixture to hydrolysis under conditions sufficient to hydrolyze the keratinous protein-containing material to form the food product ingredient.

2. The process of claim 1, wherein the keratinous protein-containing material comprises feathers, hair, wool, hide, bristles, horns, hooves, claws, nails, scales, or a mixture thereof.

3. The process of claim 1, wherein the keratinous protein-containing material comprises raw feathers.

4. The process of claim 1, wherein the keratinous protein-containing material is frozen before forming the mixture.

5. (canceled)

6. The process of claim 1, wherein the keratinous protein-containing material is cleaned by washing the keratinous protein-containing material with the cleaning solution at least once.

7. (canceled)

8. (canceled)

9. (canceled)

10. The process of claim 1, wherein the keratinous protein-containing material is subject to pretreatment with a proteolytic enzyme or a reducing agent prior to hydrolysis.

11. (canceled)

12. (canceled)

13. (canceled)

14. The process of claim 1, wherein the cereal bran is defatted before forming the mixture.

15. The process of claim 1, wherein the cereal bran is combined with a solvent prior to forming the mixture.

16. (canceled)

17. (canceled)

18. (canceled)

19. (canceled)

20. (canceled)

21. (canceled)

22. The process of claim 1, wherein the hydrolysis comprises one or multiple hydrolysis steps.

23. (canceled)

24. (canceled)

25. (canceled)

26. The process of claim 1, wherein the hydrolysis comprises steam hydrolysis.

27. (canceled)

28. (canceled)

29. (canceled)

30. The process of claim 1, wherein the hydrolysis comprises enzyme hydrolysis.

31. (canceled)

32. (canceled)

33. (canceled)

34. The process of claim 1, wherein the hydrolyzed keratinous protein-containing material is subject to further processing comprising centrifugation, filtration, decanting, drying, sifting, accumulating prior to milling, concentrating, refrigerating, freezing, pasteurizing, acidifying, further hydrolyzing, or a combination thereof.

35. (canceled)

36. The process of claim 1, wherein the mixture is subject to intermediate processing prior to hydrolysis, wherein the intermediate processing comprises removal of organic or inorganic contaminants, wetting, rinsing, size reduction, addition of a proteolytic enzyme or a reducing agent, or a combination thereof.

37. (canceled)

38. (canceled)

39. (canceled)

40. The process according to claim 1, wherein the food product ingredient has a total aroma score that is lower than a food product ingredient without cereal bran.

41. The process according to claim 1, wherein the food product ingredient has a total aroma score of less than 5.5 on a scale of 0 to 15 as measured by quantitative descriptive analysis.

42. The process according to claim 1, wherein the amount of hexanal in the food product ingredient is less than about 10 ppm and/or the peroxide value of the food product ingredient is less than about 10 mEq/kg fat.

43. A pet food product comprising the food product ingredient of claim 40.

44. The pet food product of claim 43, wherein the pet food product is a wet pet food, a semi-moist pet food, or a dry pet food.

45. The pet food product of claim 44, wherein the food product ingredient is present in the pet food product in an amount of from about 1 wt. % to about 25 wt. %.

47. A method of removing malodors from and/or increasing the palatability of a food product ingredient formed from a keratinous protein-containing material, the method comprising:
cleaning the keratinous protein-containing material with a cleaning solution,
combining the keratinous protein-containing material and a cereal bran to form a mixture, and
subjecting the mixture to hydrolysis under conditions sufficient to hydrolyze the keratinous protein-containing material to form the food product ingredient.
